(19) United States
(12) Patent Application Publication
(10) Pub. No.: US 2010/0251254 A1
(43) Pub. Date: Sep. 30, 2010

(54) INFORMATION PROCESSING APPARATUS, STORAGE MEDIUM, AND STATE OUTPUT METHOD

(75) Inventors: Naoki Nishiguchi, Kawasaki (JP); Masatomo Yasaki, Kawasaki (JP); Noboru Iwamatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/729,813

(22) Filed: Mar. 23, 2010

(30) Foreign Application Priority Data
Mar. 30, 2009 (JP) 2009-082524

(51) Int. Cl. G06F 9/50

(52) U.S. Cl. 718/104

(57) ABSTRACT

An apparatus for controlling divided operation environments includes a first acquiring unit that acquires a first processing amount indicating an amount of hardware resources allocated to each of the operation environments, a second acquiring unit that acquires a second processing amount which varies depending on an application program executed by the operation environment, a calculating unit that calculates a third processing amount of each of the operation environments on the basis of a difference between the first processing amount of each operation environment acquired by the first acquiring unit and the second processing amount of each operation environment acquired by the second acquiring unit; and an output unit that outputs a state of each of the operation environments on the basis of the third processing amount of each operation environment calculated by the calculating unit and the second processing amount of each operation environment acquired by the second acquiring unit.

### CROSS-REFERENCE TO RELATED APPLICATIONS

This application is related to and claims priority to Japanese Patent Application No. 2009-82524, filed on Mar. 30, 2009, and incorporated herein by reference.

### BACKGROUND

1. Field

The embodiments discussed herein relate to an information processing apparatus that controls operation environments, a non-transitory storage medium that stores a program used for the information processing apparatus, and a state output method.

2. Description of the Related Art

In recent years, information processing apparatuses for controlling a plurality of operation environments, such as computers for virtually controlling a plurality of virtual machines, have come into widespread use. JP-A-2008-293117 discloses such an information processing apparatus. In recent years, there has been an attempt to output information on the resources of the information processing apparatus and information on the performances of the operation environments.

However, a conventional apparatus calculates information on the performances of the operation environments on the basis of the current CPU (central processing unit) usage rate of each virtual machine, and therefore does not output appropriate information.

### SUMMARY

It is an aspect of the embodiments discussed herein to provide an information processing apparatus that controls a plurality of divided operation environments. An exemplary apparatus includes a first acquiring unit that acquires a first processing amount indicating an amount of hardware resources allocated to each of the operation environments a second acquiring unit that acquires a second processing amount which varies depending on an application program executed by the operation environment, a calculating unit that calculates a third processing amount of each of the operation environments on the basis of a difference between the first processing amount of each operation environment acquired by the first acquiring unit and the second processing amount of each operation environment acquired by the second acquiring unit, and an output unit that outputs a state of each of the operation environments on the basis of the third processing amount of each operation environment calculated by the calculating unit and the second processing amount of each operation environment acquired by the second acquiring unit.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1 illustrates a state output system;

FIG. 2 illustrates hardware and software of a physical machine and VMs;

FIG. 3 illustrates a record layout of a first file;

FIG. 4 illustrates a record layout of a load DB;

FIG. 5 illustrates a screen image displayed on a display unit of a computer;

FIG. 6 illustrates a record layout of a second file;

FIG. 7 illustrates a record layout of a third file;

FIG. 8 illustrates a record layout of a determination file;

FIG. 9 illustrates a state image displayed on the display unit of the computer;

FIG. 10 illustrates acquiring a first processing amount;

FIG. 11 illustrates outputting an application ID;

FIG. 12 illustrates outputting the application ID;

FIG. 13 illustrates acquiring a second processing amount;

FIG. 14 illustrates a calculating process;

FIG. 15 illustrates a calculating process;

FIG. 16 illustrates a calculating process;

FIG. 17 illustrates a calculating process;

FIG. 18 illustrates an example of the distribution of a third processing amount;

FIG. 19 is a flowchart illustrating the procedure of a state determining process;

FIG. 20 illustrates the hardware and software of a physical machine and VMs according to a second exemplary embodiment;

FIG. 21 illustrates the record layout of a determination file;

FIG. 22 illustrates a state determining process;

FIG. 23 illustrates the hardware and software of a physical machine and VMs according to a fourth embodiment;

FIG. 24 illustrates the record layout of a fourth file;

FIG. 25 illustrates the record layout of a determination file;

FIG. 26 illustrates a state determining process;

FIG. 27 illustrates a state image displayed on the display unit of the computer;

FIG. 28 illustrates the record layout of a determination file;

FIG. 29 is a flowchart illustrating the procedure of a state determining process;

FIG. 30 illustrates acquiring a second processing amount;

FIG. 31 illustrates the transition of the second processing amount;

FIG. 32 illustrates acquiring the second processing amount;

FIG. 33 illustrates acquiring the second processing amount;

FIG. 34 illustrates the hardware and software of a physical machine and VMs according to an eighth embodiment;

FIG. 35 illustrates acquiring a second processing amount;

FIG. 36 illustrates acquiring the second processing amount;

FIG. 37 illustrates an exemplary second processing amount;

FIG. 38 illustrates hardware and software of a physical machine and VMs according to a ninth embodiment;

FIG. 39 illustrates a state output system according to a tenth embodiment; and

FIG. 40 illustrates hardware and software of a server computer and application servers according to the tenth embodiment.

### DESCRIPTION OF EMBODIMENTS

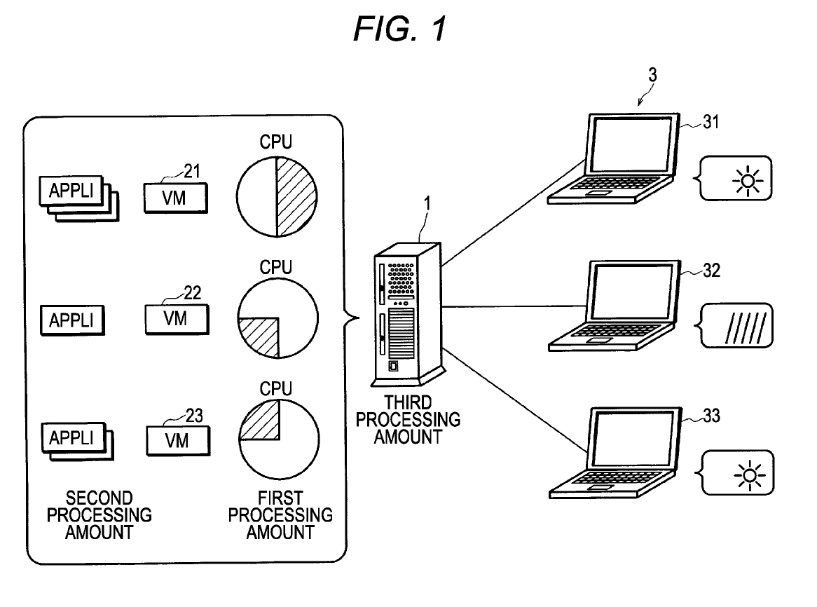

FIG. 1 illustrates a state output system. The state output system includes, for example, an information processing apparatus 1, operation environments 21, 22, 23, . . . (hereinafter, abbreviated as 2 according to circumstances) and terminal apparatuses 31, 32, 33, . . . (hereinafter, abbreviated as 3 according to circumstances). An example in which the state output system is applied to a physical machine that controls a plurality of virtual machines (hereinafter, referred to as VMs) is disclosed. The information processing apparatus 1 is, for example, a server computer or a personal computer. The terminal apparatus 3 is, for example, a personal computer or an input/output apparatus that has a communication function, an input/output device, and a monitor. The terminal apparatus 3 may include input/output devices, such as a monitor, a keyboard, and a mouse. In this case, the physical machine and the terminal apparatus 3 may be connected to each other wirelessly or by a cable such as a display cable. For example, in the following description, the information processing apparatus 1 is a physical machine 1 and the terminal apparatus 3 is a personal computer (hereinafter, referred to as a computer 3).

The computer 3 and the physical machine 1 may be connected to each other by a USB (universal serial bus) cable or a communication network, such as the Internet or a LAN (local area network), and transmit or receive information according to a predetermined protocol. The computer 3 may be connected to the physical machine 1 by the LAN. The user of the computer 3 starts the operation environment 2 (hereinafter, referred to as a VM 2) through the physical machine 1. A plurality of VMs 21, 22, 23, . . . that is logically divided is operated on the physical machine 1. In this embodiment, an example in which the physical machine 1 controls three VMs 2, that is, the VMs 21 to 23 is described, but the number of VMs is not limited to three.

The physical machine 1 allocates, to each VM 2, a first processing amount indicating the amount, of hardware resource (hereinafter, referred to as a hardware resource) of the physical machine 1 allocated to each VM 2. In the example illustrated in FIG. 1, the first processing amount indicates a CPU usage rate, which is one of the hardware resources, allocated from the physical machine 1 to each VM 2. As represented by a circle graph, as can be seen from comparison to the VM 22 and the VM 23, the first processing amount allocated to the VM 21 is more than that allocated to the VM 22 and the VM 23. That is, in the circle graph illustrated in FIG. 1, the first processing amount allocated to each VM is hatched. The VM 2 executes an application program (hereinafter, referred to as an application) on each VM 2. A second processing amount varies depending on the kind of application being executed, the number of applications being executed, or the content of the process of the application being executed.

The physical machine 1 acquires the first processing amount and the second processing amount from each of the VMs 2. The physical machine 1 calculates the third processing amount of each VM 2 on the basis of the difference between the first processing amount and the second processing amount acquired from each VM 2. The physical machine 1 outputs the state of each VM 2 on the basis of the calculated third processing amount and the second processing amount. The state of the VM 2 is output from the physical machine 1 as an icon indicating, for example, sunny or rain to the computer 3 and is then displayed on the display unit. When an icon indicating sunny is displayed, the state of the VM 2 is good, and it is expected that the process will be performed at a high speed. Meanwhile, when an icon indicating rain is displayed, the state of the VM 2 is bad and it is hardly expected that the process will be performed at a high speed. In this case, the icon indicates the possibility that it takes a long time to perform the process.

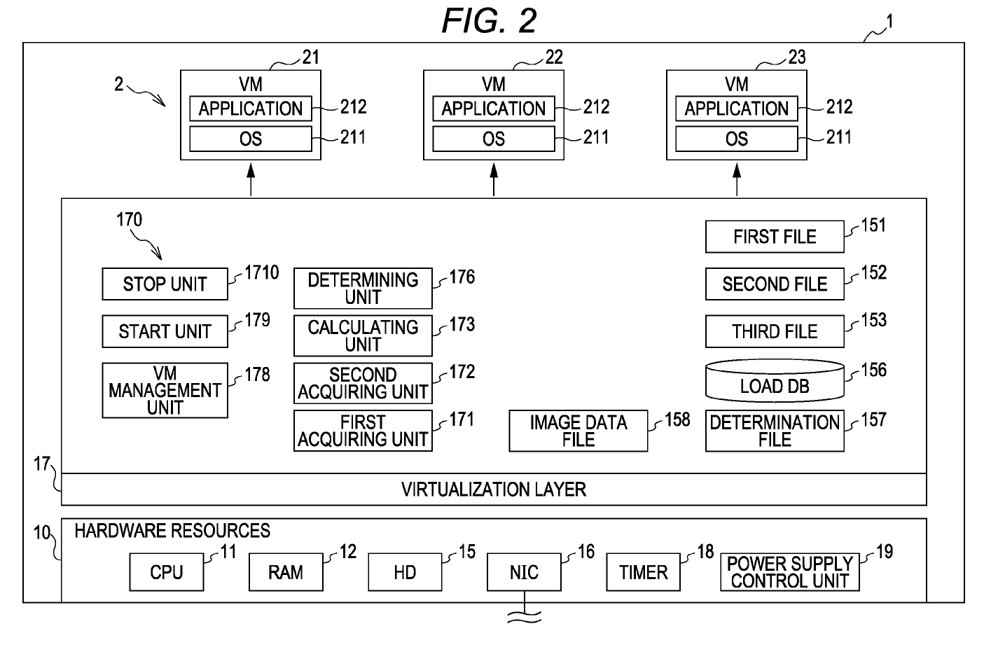

FIG. 2 illustrates the hardware and software of the physical machine 1 and the VMs 2. The physical machine 1 includes hardware resources 10 and a virtualization layer 17. The hardware resources 10 include, for example, a CPU 11, a RAM (random access memory) 12, a storage unit (HD) 15, a NIC (network interface card) 16, a timer 18, and a power supply control unit 19. The hardware resources 10 are under the control of the virtualization layer 17, which is a virtualization software. The CPU 11 controls hardware components connected thereto through a bus (not illustrated) in response to instructions from the virtualization layer 17 and a control module 170 on the virtualization layer 17.

The RAM 12 is a memory such as an SRAM (static RAM), a DRAM (dynamic RAM), or a flash memory. The RAM 12 temporarily stores various data that is generated when the CPU 11 executes various programs such as the virtualization layer 17. The storage unit is, for example, a hard disk or a high-capacity memory. In this embodiment, the storage unit is assumed to be a hard disk, and is hereinafter referred to as the HD 15. The HD 15 stores, for example, files created by the VM 2 and various data to be stored by instructions from the virtualization layer 17. The NIC 16 is, for example, an Ethernet card, and transmits or receives information to or from the computer 3 or a web server (not illustrated) according to, for example, an HTTP (hypertext transfer protocol). The timer 18 outputs temporal information to the CPU 11.

The control module 170 cooperated with the virtualization layer 17 performs various processes including a process of monitoring the applications executed by the VMs 21, 22, and 23, a process of acquiring or calculating the first to third processing amounts, a process of starting or stopping the VMs 2, and a process of managing the supply of power to the physical machine 1. The control module 170 includes, for example, a first acquiring unit 171, a second acquiring unit 172, a calculating unit 173, a determining unit 176, a VM management unit 178, a start unit 179, and a stop unit 1710. The control module 170 is loaded to the RAM 12 and is then executed. For ease of description of the control module 170, only the main modules are illustrated in FIG. 2, and the other modules are illustrated.

For example, a first file 151, a second file 152, a third file 153, a load database (hereinafter, referred to as a DB) 156, a determination file 157, and an image data file 158 are stored in the RAM 12 or the HD 15. In this embodiment, hypervisor-type virtualization software in which the virtualization layer 17 is directly operated on the hardware resource 10 is used, but the invention is not limited thereto. For example, a host type in which virtualization software is operated on Windows (registered trademark) or Linux (registered trademark) may be used.

The physical machine 1 in a stationary state starts up and the user who wants to use the VM 21 uses the computer 3 to start the physical machine 1. The computer 3 outputs a start command to the physical machine 1. In addition, the computer 3 outputs identification information (hereinafter, referred to as a VMID) for specifying one of the plurality of VMs 2 which the user wants to start and a start command for the VM 2 to the physical machine 1. In this embodiment, an example in which the VM 21 starts is disclosed. The NIC 16 corresponds to Wake On Lan, receives a start command for the physical machine 1, and outputs the start command to the power supply control unit 19. The computer 3 outputs a magic packet for turning on the physical machine 1 to the NIC 16.

The power supply control unit 19 supplies power from an AC power supply (not illustrated) to the physical machine 1. The physical machine 1 starts up and the virtualization layer 17 and the control module 170 also start up. The start unit 179 starts the VM 21 and outputs a start command to the VM management unit 178. The VM 21 is operated under the control of the virtualization layer 17. An OS (operating system) 211 installed in the VM 21 performs various applications 212. The applications 212 include, for example, a document creating application, a browser, a table calculation and document creating application, a PDF (registered trademark: portable document format) viewer, a mailer, or a presentation document creating application. The applications 212 may include a music or image reproducing application or a DVD (digital versatile disc) reproducing application.

The VM 21 outputs screen information to the computer 3 through the NIC 16. Similarly, another user may operate another computer 3 to use the VM 22 and the VM 23. When the VM 22 is used, another computer 3 outputs the VMID of the VM 22 and a start command for the VM 22 to the physical machine 1. The start unit 179 receives them to starts up the VM 22. In addition, unique user identification information for specifying the user may be given and a plurality of users may share the VM 21.

When the computer 3 outputs a stop command for the VM 21, the stop unit 1710 receives the stop command and stops the VM 21. The stop unit 1710 outputs the stop command to the VM management unit 178. In this way, the hardware resources 10 used by the VM 21 are released. The stop of the VM 21 means that the OS 211 and the applications 212 used by the VM 21 are all shut down and information in the area of the RAM 12 is opened without being stored in the HD 15. In this embodiment, an example in which the VM 21 stops is described, but the VM 21 may be interrupted.

The interruption of the VM 21 means, for example, that information in the area of the RAM 12 used by the VM 21 is stored in the HD 15 and the VM 21 hibernates (or is suspended). In this case, the area of the RAM 12 used by the VM 21 is opened. When the VM 21 restarts after hibernation (or suspension), the information stored in the HD 15 is stored in the area of the RAM 12, and the work during interruption is restored. In addition, the interruption of the VM 21 may be a suspended state (or a sleeping or standby state) in which the information in the area of the RAM 12 used by the VM 21 is stored in the RAM 12 and the power supply control unit 19 continuously supplies power to the RAM 12. When the VM 21 restarts after the suspended state (or a sleeping or standby state), the VM 21 uses the information stored in the area of the RAM 12 to restore the work during interruption promptly. An example in which the VM 2 is in one of an operating state and a stationary state is disclosed.

The VM management unit 178 monitors the operating states or the stationary states of the VMs 21 to 23, and allocates the hardware resources 10 under predetermined conditions stored in the HD 15. The first processing amount, which is one of the hardware resources 10 allocated, is, for example, a CPU usage rate, an HD usage rate, or a NIC usage rate. The CPU usage rate means the ratio of the time when the VM 2 being operated occupies the CPU 11. For example, when the CPU usage rate is 50%, the corresponding VM 2 occupies the CPU 11 for 0.5 second with respect to 1 second.

When the CPU usage rate is 100%, the corresponding VM 2 occupies the CPU 11 for 1 second. For example, when two CPUs 11 are used as in an Intel Core Duo (registered trademark) processor and the CPU usage rate thereof is 100%, which is half of 200%, the corresponding VM 2 occupies the two CPUs 11 for 0.5 second with respect to 1 second. This does not means that the VM 2 continuously occupies the CPUs 11 for 0.5 second, but means that the occupancy of the VM 2 in the two CPUs 11 or the occupation time varies but the half of the CPUs 11 are used for one second. Similarly, the HD usage rate means the ratio of the time when the VM 2 being operated occupies the HD 15, and the NIC usage rate means the ratio of the time when the VM 2 being operated occupies the NIC 16. In this embodiment, for ease of description, the CPU usage rate allocated from the VM management unit 178 to each VM 2 is used as an example of the first processing amount. In addition, in this embodiment, it is assumed that the CPU 11 includes two processors and the maximum first processing amount that can be allocated (hereinafter, referred to as a maximum first processing amount) is 200%.

The VM management unit 178 determines the first processing amount of each VM 2 under the predetermined conditions stored in the HD 15, and outputs the determined first processing amount to the first acquiring unit 171. For example, the VM management unit 178 may uniformly allocate the first processing amount to the VMs 2 that are being operated. When the VM 21 and the VM 22 are being operated, the VM management unit 178 uniformly allocates a first processing amount of 100% to each of the VM 21 and the VM 22. In addition, the VM management unit 178 may determine the first processing amount on the basis of the operating state of the VM 2 and the temporal information output from the timer 18. In addition, the Xen (registered trademark) Credit Scheduler may be used. In this case, a weight is set to each VM 2. The VM management unit 178 determines the first processing amount on the basis of the weight given to each VM 2.

For example, when a weight of 1 is set to the VM 21, a weight of 2 is set to the VM 22, and a weight of 1 is set to the VM 23, the first processing amount of the VM 21 is 50%, the first processing amount of the VM 22 is 100%, and the first processing amount of the VM 23 is 50%. In addition, 200% of the first processing amount is not necessarily allocated, but a portion of the maximum first processing amount, for example, 180% of the first processing amount may be allocated. Alternatively, the weight may be given according to the temporal information. For example, in the first half, a weight of 1 may be given to the VM 21, a weight of 2 may be given to the VM 22, and a weight of 1 may be given to the VM 23. In the second half, a weight of 2 may be given to the VM 21, a weight of 1 may be given to the VM 22, and a weight of 1 may be given to the VM 23. An example in which a weight of 1 is set to the VM 21, a weight of 2 is set to the VM 22, and a weight of 1 is set to the VM 23 is disclosed.

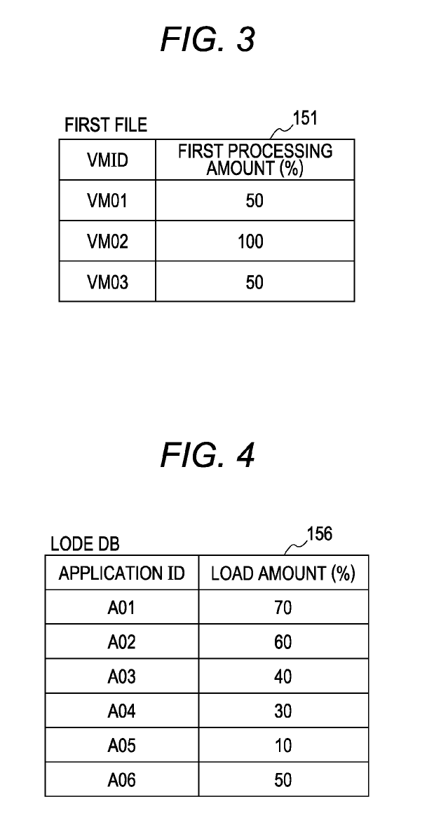

FIG. 3 illustrates the record layout of the first file 151. The first acquiring unit 171 stores the first processing amount of each VM 2 acquired from the VM management unit 178 in the first file 151. The first file 151 includes, for example, a VMID field and a first processing amount field. The VMID is stored in the VMID field and the first processing amount is stored in the first processing amount field so as to be associated with the VMID. When the VM 2 starts or stops, the VM management unit 178 determines the first processing amount of each VM 2 after the VM 2 starts or stops, and outputs the determined first processing amount to the first file 151. The first acquiring unit 171 updates the content stored in the first file 151 using the start or stop of the VM 2 as a trigger.

FIG. 4 illustrates the record layout of the load DB 156. The load DB 156 includes, for example, an application ID field and a load amount field. The application ID, which is identification information for specifying the application 212 executed by the VM 2, is stored in the application ID field. The load amount is stored in the load amount field so as to be associated with the application ID. The load amount is referred to when the second processing amount that varies depending on the application 212 executed by the VM 2 is determined. The load DB 156 may be shared by all the VMs 2, or it may be provided for each VM 2. In this way, even when the same application 212 is used, the different VMs 2 may have different load amounts. The second processing amount is a value that is predicted as the amount of hardware resources 10 consumed by the application 212 executed by the VM 2, and is determined on the basis of the load DB 156.

The amount of hardware resources 10 consumed by the application 212 that is being executed is varied in real time. Therefore, in this embodiment, the predicted maximum amount of hardware resources 10 consumed by the application 212 that is being executed is stored as the load amount. The load amount is any one of the CPU 11, the HD 15, and the NIC 16. In this embodiment, the load amount of the CPU 11 is disclosed as an example. For example, an application ID ‘A04 ’ is given to a browser and a load amount of ‘30’ is stored. In addition, in the case of a DVD reproducing application (application ID ‘A06 ’) in which the CPU 11 consumes a relatively large amount of hardware resources, a load amount of ‘50’ is stored.

The operator may use, for example, the keyboard (not illustrated) of the computer 3 to appropriately change the value of the load amount stored in the load DB 156. In this embodiment, the predicted maximum amount of resources of the CPU 11 consumed by the application 212 that is being executed is used as an example of the load amount, but the invention is not limited thereto. For example, the load amount may be the average value of the predicted amount of resources of the CPU 11 consumed by the application 212 or may be the maximum value multiplied with a predetermined coefficient (for example, 0.8 or 1.2), or the maximum value to which the predetermined coefficient may be added, or the maximum value from which the predetermined coefficient may be subtracted. In addition, the value may be appropriately changed according to the design.

The OS 211 of the VM 2 outputs the application ID of the application 212 being executed to the second acquiring unit 172. The second acquiring unit 172 acquires as the second processing amount a load amount corresponding to the application ID from the load DB 156. When a plurality of applications 212 is executed in the VM 2, the OS 211 outputs the application ID of one of the applications 212 that is currently selected. The second acquiring unit 172 reads a load amount corresponding to the application ID from the load DB 156 and uses the read load amount as the second processing amount.

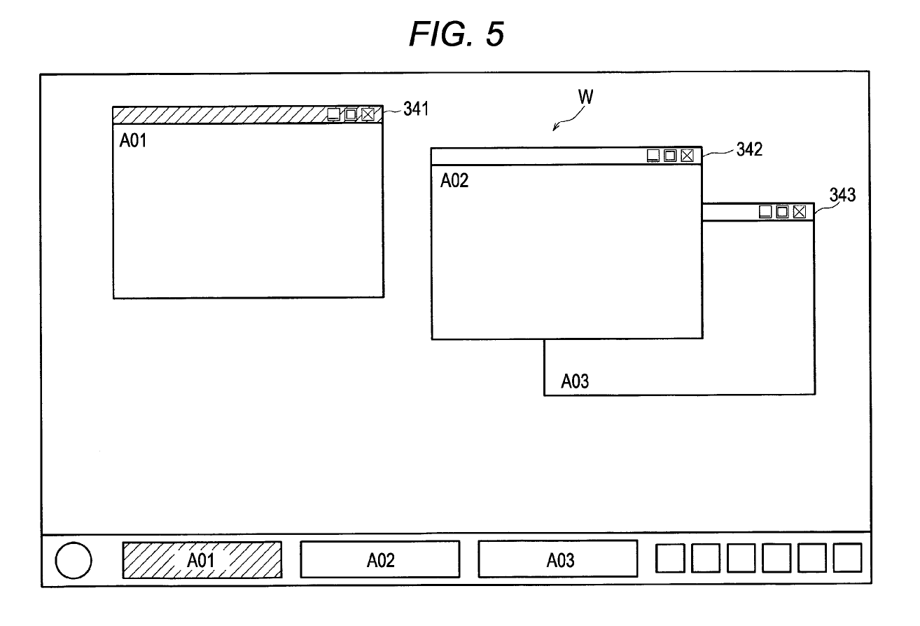

FIG. 5 illustrates a screen image displayed on the display unit of the computer 3. The user of the computer 3 uses the VM 2 being operated to execute the application 212. In the example illustrated in FIG. 5, for example, three applications 212 are executed. A window 341 with an application ID ‘A01 ’, a window 342 with an application ID ‘A02 ’, and a window 343 with an application ID ‘A03 ’ are displayed on the display unit. The user uses, for example, the mouse (not illustrated) of the computer 3 to select one of the windows 341, 342, and 343 (hereinafter, the windows are representatively referred to as a window W according to circumstances) which the user wants to use.

The information of the window W selected by the computer 3 is output to the OS 211 through the NIC 16. As can be seen from FIG. 5, the window 341 is selected. The other windows 342 and 343 are in a non-selected state. In this state, when the window 342 is clicked, the window 342 is selected and the windows 341 and 343 are in the non-selected state. Instead of clicking the window W to select it, the user may click a rectangular button on a task bar that is displayed on the lower side of the display unit to select the window W. When a new application 212 starts, the newly started application 212 is the selected application 212. When the application 212 is shut down, the previously selected application 212 or the application 212 related to the uppermost window W is the selected application 212. When the application 212 is selected, the OS 211 outputs the application ID of the selected application to the second acquiring unit 172. In addition, the user may click portions other than the window W to select no application 212. In this case, non-execution information indicating that no application 212 is selected is output to the second acquiring unit 172.

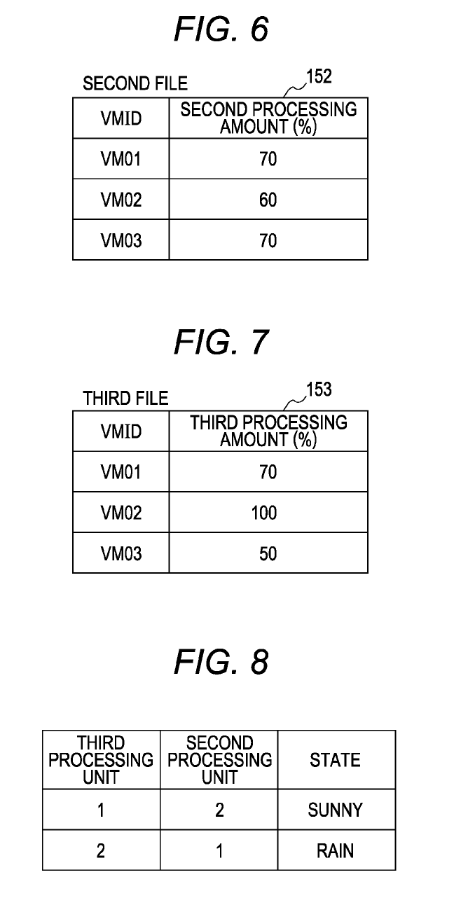

FIG. 6 illustrates the record layout of the second file 152. The second file 152 includes, for example, a VMID field and a second processing amount field. The second processing amount of each VM 2 is stored in the second processing amount field so as to be associated with the VMID. The second acquiring unit 172 extracts a load amount from the load DB 156 on the basis of the application ID output from the OS 211 of each VM 2. The second acquiring unit 172 stores the extracted load amount corresponding to the VMID as the second processing amount in the second file 152. As such, the content stored in the second file 152 varies depending on the selection of the execution or the shutdown of the application 212 executed by the VM 2. The record layouts of various files described in this embodiment are just illustrative, and the invention is not limited thereto. When association between data is ensured, it is possible to store other data in the fields.

The first acquiring unit 171 acquires the first processing amount using the stop or start of the VM 2 as a trigger, and outputs the acquired first processing amount to the calculating unit 173. The second acquiring unit 172 acquires the second processing amount of each VM 2 using the selection of the application 212 of each VM 2 as a trigger and outputs the acquired second processing amount to the calculating unit 173. The calculating unit 173 calculates the third processing amount of each VM 2 on the basis of the difference between the first processing amount and the second processing amount of each VM 2 whenever the first processing amount or the second processing amount of each VM 2 is changed. Calculating the third processing amount is disclosed with reference to the following flowcharts.

FIG. 7 illustrates the record layout of the third file 153. The third file 153 includes, for example, a VMID field and a third processing amount field. The third processing amount output together with the VMID from the calculating unit 173 is stored in the third processing amount field so as to be associated with the VMID. The second acquiring unit 172 outputs the acquired second processing amount of each VM 2 to the determining unit 176. The calculating unit 173 outputs the calculated third processing amount of each VM 2 to the determining unit 176. The determining unit 176 determines the state of each VM 2 on the basis of the magnitude relationship between the second processing amount and the third processing amount of each VM 2. The determining unit 176 determines the state of each VM 2 with reference to the determination file 157.

FIG. 8 illustrates the record layout of the determination file 157. The determination file 157 includes, for example, a third processing amount field, a second processing amount field, and a state field. Numbers indicating the magnitude relationship between the third processing amount and the second processing amount are stored in the third processing amount field and the second processing amount field. The numbers written in the third processing amount field and the second processing amount field illustrated in FIG. 8 indicate the order of the processing amounts when the processing amounts are arranged in descending order. That is, as the number is decreased, ranking is high and the value of the processing amount is increased. Information indicating the state of the hardware resources 10 of the VM 2 is stored in the state field. For example, when the third processing amount is more than the second processing amount, a state ‘sunny’ is read on the basis of ‘1 ’ (rank) in the third processing amount field and ‘2 ’ (rank) in the second processing amount field. On the other hand, when the third processing amount is less than the second processing amount, a state ‘rain’ is read on the basis of ‘2 ’ in the third processing amount field and ‘1 ’ in the second processing amount field.

When the third processing amount of the VM 2 is more than the second processing amount that varies depending on the application 212 being executed, the state of the application 212 is represented by ‘sunny’ since the application 212 can be used well. The state ‘rain’ indicates that the third processing amount is less than the second processing amount. Since the third processing amount of the VM 2 is less than the second processing amount that varies depending on the application 212 being executed, the process of the application 212 is likely to be delayed, and the state is represented by ‘rain’. In addition, ‘sunny’ indicating that the state is comfortable, ‘rain’ indicating that the state is uncomfortable, and the content of the determination file 157 according to this embodiment are just an illustrative example, and the invention is not limited thereto. When the values are equal to each other, for example, when the third processing amount is equal to the second processing amount, a similar process as described above may be performed considering that one of the third processing amount and the second processing amount is more than the other processing amount.

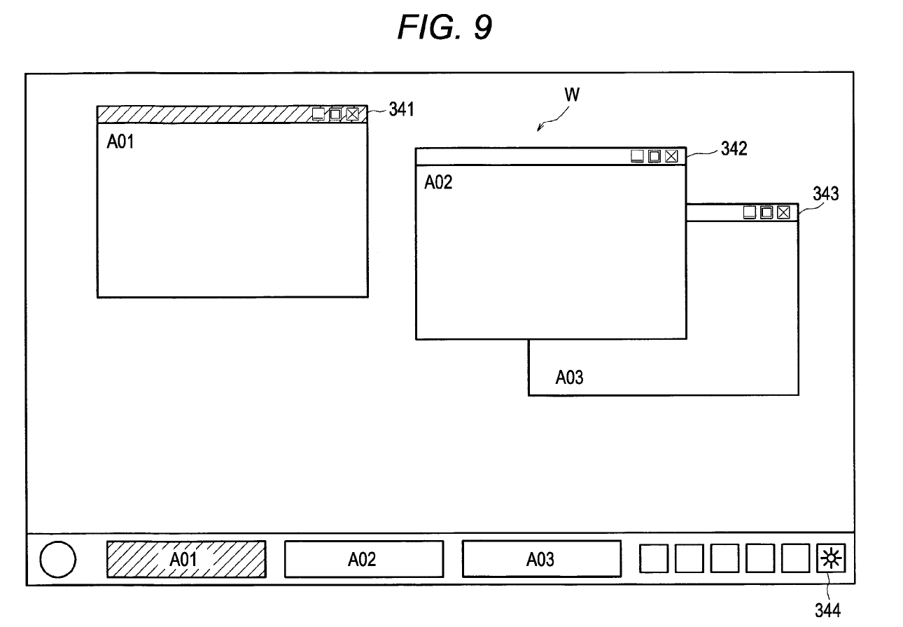

FIG. 9 illustrates a state image displayed on the display unit of the computer 3. The determining unit 176 determines the state of each VM 2 with reference to the determination file 157 and reads image data corresponding to the determined state from the image data file 158. The image data file 158 stores various image data so as to be associated with the state. For example, the image data file 158 stores images used for the weather forecast, such as sunny, rain, cloudy with occasional rain, and sunny with occasional cloudy. The state ‘cloudy’ indicates that the state is appropriate, and is between the comfortable state ‘sunny’ and the uncomfortable state ‘rain’. The determining unit 176, serving as an output unit, outputs image data corresponding to the read state to the OSs 211 of the VMs 21, 22, and 23 with reference to the VMIDs. Alternatively, when a value obtained by subtracting the second processing amount from the third processing amount is positive, the determining unit 176 may output ‘sunny’ indicating that the state becomes better. When the value obtained by subtracting the second processing amount from the third processing amount is negative, the determining unit 176 may output ‘rain’ indicating that the state becomes worse.

The OS 211 displays image data 344 related to the state on the task bar, as illustrated in FIG. 9. In this embodiment, the image data 344 is displayed on the task bar, but the invention is not limited thereto. For example, the image data 344 may be output onto a desktop. In addition, the image data 344 may be displayed as a gadget on the side bar of the Windows (registered trademark). Alternatively, any other image data 344 may be used as long as it indicates the state. For example, when the state is divided into three stages, that is, 1 indicating that the state is good, 2 indicating that the state is normal, and 3 indicating that the state is bad, color image data 344 such as blue, yellow, and red may be output. In addition, the image data 344 related to facial expression, such as a laughing face, a smiling face, or a crying face, may be output. Further, text data or music data corresponding to feelings, such as good, middle, and bad, not the image data 344, may be output.

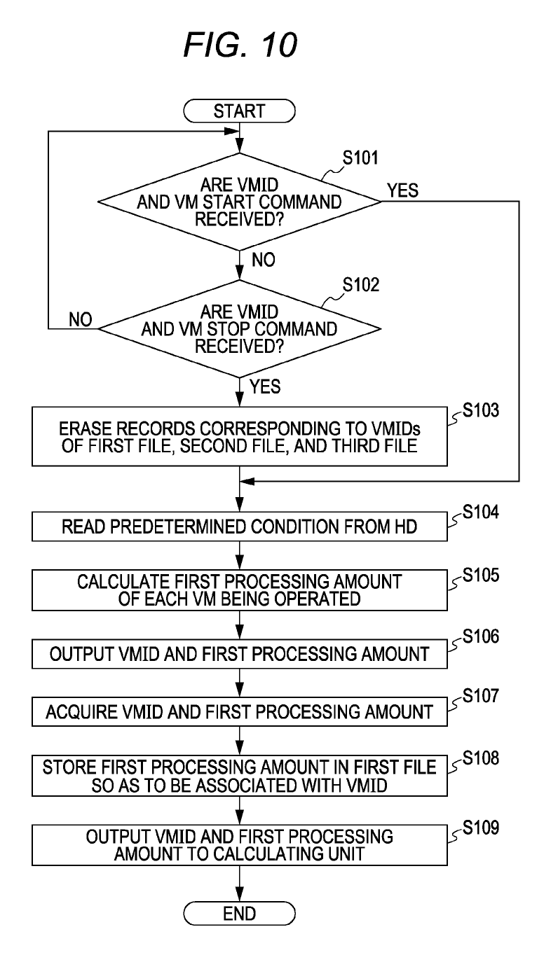

FIG. 10 illustrates acquiring the first processing amount. The VM management unit 178 determines whether a VMID and a start command for the VM 2 are received from the computer 3 through the start unit 179 (Operation S101). If it is determined that the VMID and the start command for the VM 2 are not received through the start unit 179 (Operation S101: NO), the VM management unit 178 proceeds to Operation S102. The VM management unit 178 determines whether a VMID and a stop command for the VM 2 are received from the computer 3 through the stop unit 1710 (Operation S102).

If it is determined that the VMID and the stop command for the VM 2 are not received through the stop unit 1710 (Operation S102: NO), the VM management unit 178 proceeds to Operation S101. On the other hand, if it is determined that the VMID and the stop command for the VM 2 are received through the stop unit 1710 (Operation S102: YES), the VM management unit 178 proceeds to Operation S103. The VM management unit 178 erases a record corresponding to the VMID in the stop command for the VM 2 in the first file 151, the second file 152, and the third file 153 (Operation S103).

After Operation S103 and if it is determined in Operation S101 that the VMID and the start command for the VM 2 are received (Operation S101: YES), the VM management unit 178 reads a predetermined condition from the HD 15 (or the RAM 12) (Operation S104). The VM management unit 178 calculates the first processing amount of each VM 2 that is being operated, on the basis of the weight given to the VM 2 being operated (Operation S105). The VM management unit 178 reads the maximum first processing amount and the weight related to the VM 2 that is currently being operated from the HD 15. The VM management unit 178 calculates the first processing amount of each VM 2 such that, as the weight is increased, the first processing amount is increased.

The VM management unit 178 outputs the VMID and the calculated first processing amount of each VM 2 to the first acquiring unit 171 (Operation S106). The first acquiring unit 171 acquires the VMID and the first processing amount (Operation S107). The first acquiring unit 171 stores the first processing amount in the first file 151 so as to be associated with the VMID (Operation S108). The first acquiring unit 171 outputs the VMID and the first processing amount of each VM 2 that is being operated to the calculating unit 173 (Operation S109).

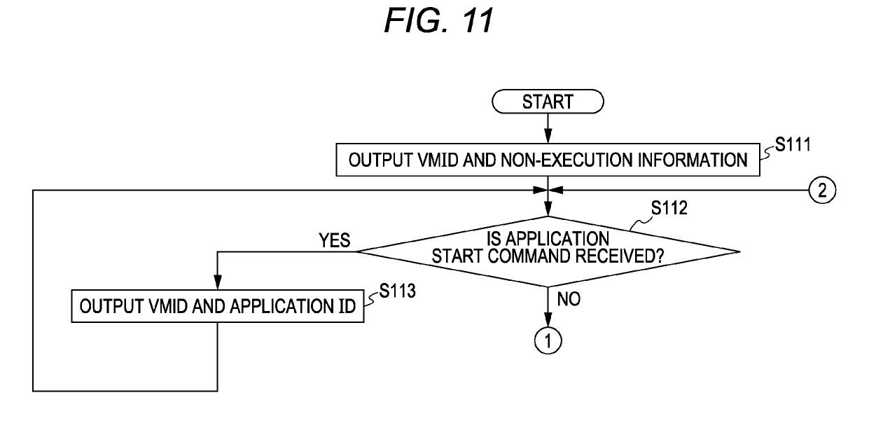

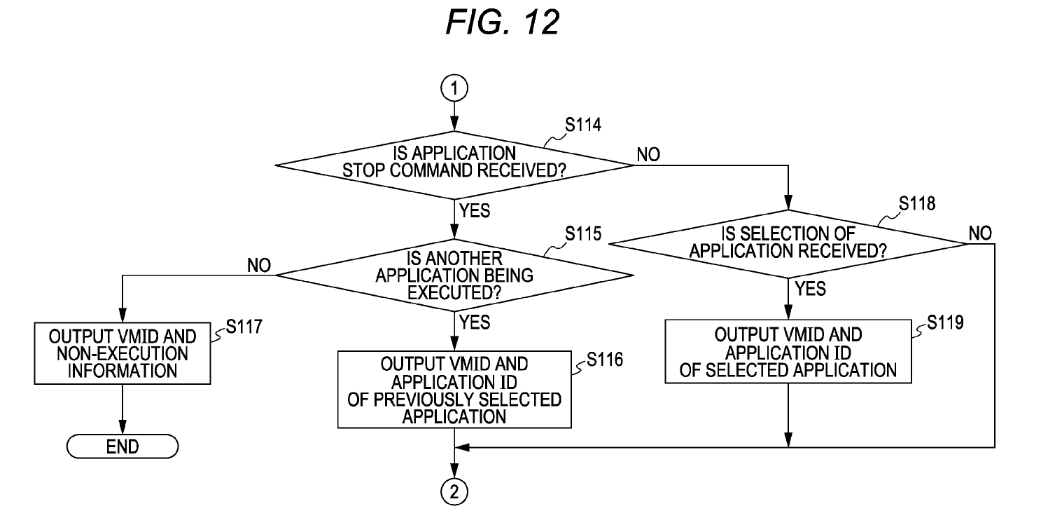

FIGS. 11 and 12 illustrate a process of outputting the application ID. The OS 211 of the VM 2 that is being operated performs the following process. It is assumed that the application 212 is not executed at the beginning of the start of the OS 211. The OS 211 outputs the VMID and non-execution information indicating that the application 212 is not executed to the second acquiring unit 172 (Operation S111). The OS 211 determines whether a start command for the application 212 is received from the computer 3 through the NIC 16 (Operation S112).

If it is determined that the start command for the application 212 is received (Operation S112: YES), the OS 211 outputs the VMID and the application ID to the second acquiring unit 172 (Operation S113). The process returns to Operation S112. If it is determined that the start command for the application 212 is not received (Operation S112: NO), the OS 211 determines whether a stop command for the application 212 is received (Operation S114). If it is determined that the stop command for the application 212 is received (Operation S114: YES), the OS 211 determines whether another application 212 is being executed (Operation S115).

If it is determined that another application 212 is not being executed (Operation S115: NO), the OS 211 outputs the VMID and the non-execution information to the second acquiring unit 172 (Operation S117). If it is determined that another application 212 is being executed (Operation S115: YES), the OS 211 proceeds to Operation S116. The OS 211 outputs the VMID and the application ID of another application that has been previously selected in time series to the second acquiring unit 172 (Operation S116). The process returns to Operation S112.

If it is determined that the stop command for the application 212 is not received (Operation S114: NO), the OS 211 determines whether the selection of the application 212 being operated is received (Operation S118). If it is determined that the selection of the application 212 is not received (Operation S118: NO), the OS 211 returns the process to Operation S112. If it is determined that the selection of the application 212 is received (Operation S118: YES), the OS 211 outputs the VMID and the application ID of the selected application 212 to the second acquiring unit 172 (Operation S119). The process returns to Operation S112.

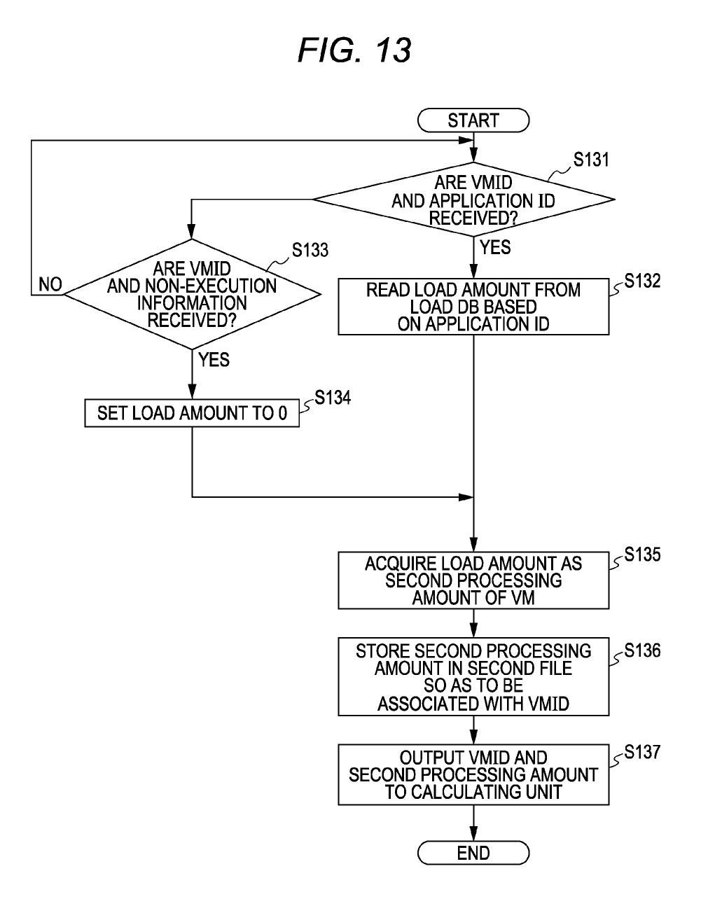

FIG. 13 illustrates a acquiring the second processing amount. The second acquiring unit 172 determines whether the VMID and the application ID are received from each VM 2 (Operation S131). If it is determined that the VMID and the application ID are received (Operation S131: YES), the second acquiring unit 172 reads a load amount from the load DB 156 on the basis of the application ID (Operation S132). If it is determined that the VMID and the application ID are not received (Operation S131: NO), the second acquiring unit 172 determines whether the VMID and the non-execution information are received from each VM 2 (Operation S133). If it is determined that the VMID and the non-execution information are not received (Operation S133: NO), the second acquiring unit 172 returns the process to the Operation S131.

If it is determined that the VMID and the non-execution information are received (Operation S133: YES), the second acquiring unit 172 sets the load amount to 0 (Operation S134). That is, since there is no application 212 that is being operated, the load amount and the second processing amount are set to the minimum values. After Operations S134 and S132, the second acquiring unit 172 acquires the load amount in Operation S134 or S132 as the second processing amount of the VM 2 (Operation S135). The second acquiring unit 172 stores the acquired second processing amount in the second file 152 so as to be associated with the VMID (Operation S136). The second acquiring unit 172 outputs the VMID and the acquired second processing amount to the calculating unit 173 (Operation S137).

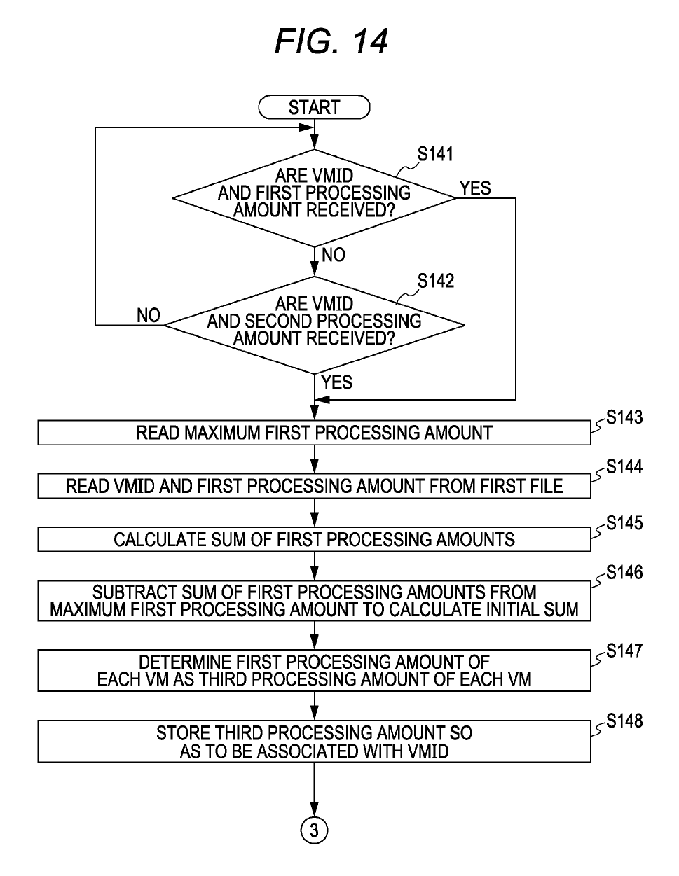

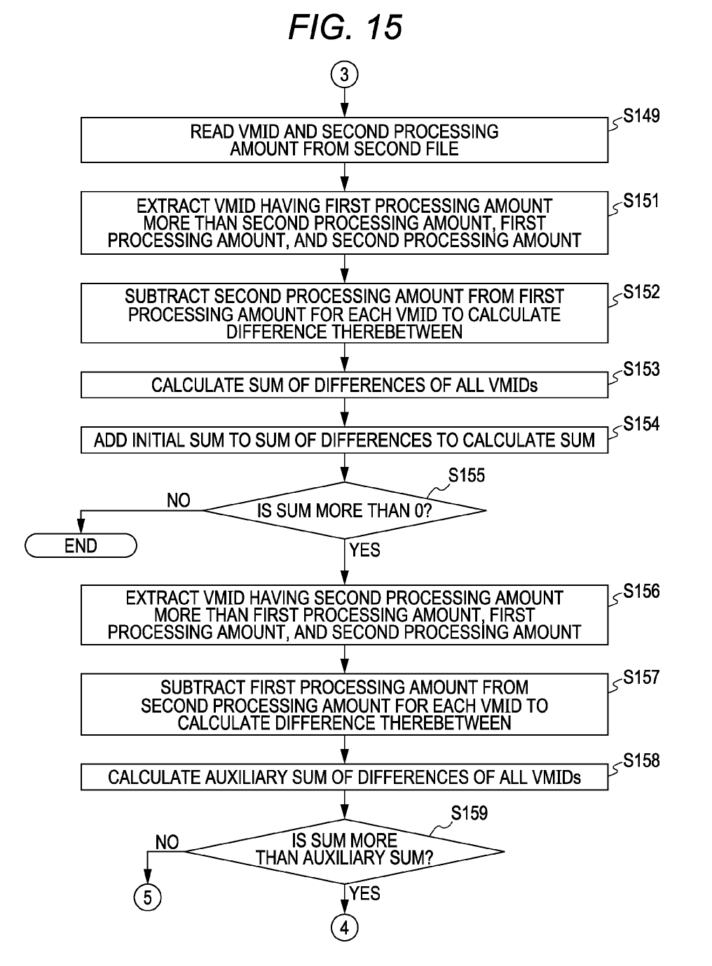

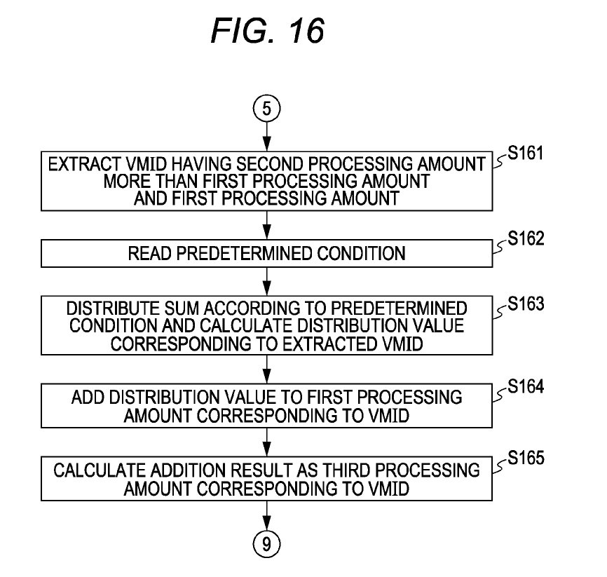

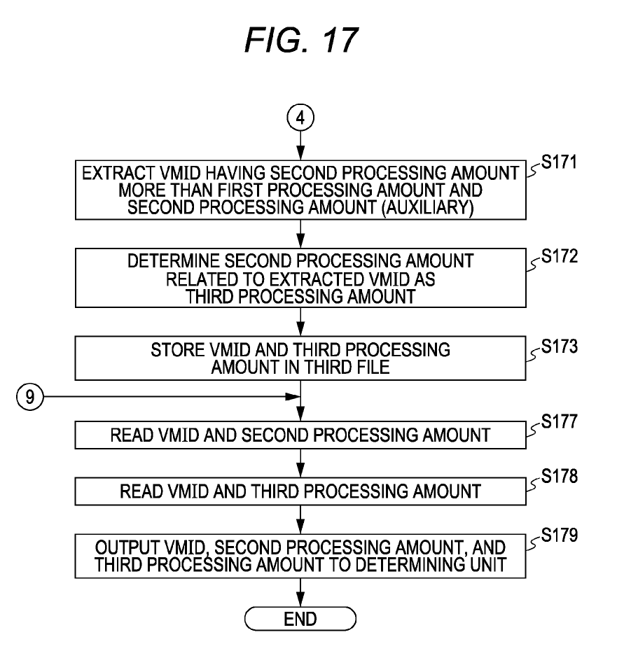

FIGS. 14 to 17 are flowcharts illustrating the procedure of a calculating process. The calculating unit 173 determines whether the VMID and the first processing amount are received from the first acquiring unit 171 (Operation S141). If it is determined that the VMID and the first processing amount are not received (Operation S141: NO), the calculating unit 173 determines whether the VMID and the second processing amount are received from the second acquiring unit 172 (Operation S142). If it is determined that the VMID and the second processing amount are not received (Operation S142: NO), the calculating unit 173 returns the process to Operation S141

If it is determined that the VMID and the first processing amount are received (Operation S141: YES) or if it is determined that the VMID and the second processing amount are received (Operation S142: YES), the calculating unit 173 proceeds to Operation S143. The calculating unit 173 reads the maximum first processing amount stored in the HD 15 (Operation S143). For example, when two CPUs 11 are provided, the maximum first processing amount may be 200% which is two times the CPU usage rate of 100% of one CPU 11. The calculating unit 173 reads the VMID and the first processing amount from the first file 151 (Operation S144). The records of the first to third files 151 to 153 of the VM 2 that is in the stationary state are removed by the process of Operation S103.

The calculating unit 173 calculates the sum of the read first processing amounts (Operation S145). The calculating unit 173 subtracts the sum of the first processing amounts from the maximum first processing amount read in Operation S143 to calculate an initial sum (Operation S146). The calculating unit 173 determines the first processing amount corresponding to the VMID of each VM 2 that is read in Operation S144 as the third processing amount of each VM 2 (Operation S147). The calculating unit 173 stores the third processing amount in the third file 153 so as to be associated with the VMID (Operation S148).

The calculating unit 173 reads the VMID and the second processing amount from the second file 152 (Operation S149). The calculating unit 173 extracts combinations of the VMID in which the read first processing amount is more than the second processing amount, the first processing amount, and the second processing amount (Operation S151). The calculating unit 173 subtracts the second processing amount from the first processing amount corresponding to each VMID to calculate the difference therebetween for the extracted combinations (Operation S152).

The calculating unit 173 performs the process of Operation S152 on all the combinations to calculate the sum of the differences of all the VMIDs (Operation S153). The calculating unit 173 adds the initial sum calculated in Operation S146 to the sum of the differences to calculate a sum (Operation S154). The calculating unit 173 determines whether the sum is more than 0 (Operation S155). If it is determined that the sum is not more than 0 (Operation S155: NO), the calculating unit 173 ends the process.

If it is determined that the sum is more than 0 (Operation S155: YES), the calculating unit 173 extracts combinations of the VMID in which the second processing amount is more than the first processing amount, the first processing amount, and the second processing amount (Operation S156). The calculating unit 173 subtracts the first processing amount from the second processing amount to calculate the difference therebetween for each extracted VMID (Operation S157). The calculating unit 173 adds the differences of all the VMIDs to calculate the auxiliary sum of the differences (Operation S158). The calculation of the auxiliary sum is just an illustrative example, and the invention is not limited thereto. For example, when the second processing amount is more than the first processing amount, the sum of the first processing amounts may be subtracted from the sum of the second processing amounts to calculate the auxiliary sum.

The calculating unit 173 determines whether the sum is equal to or more than the auxiliary sum (Operation S159). If it is determined that the sum is less than the auxiliary sum (Operation S159: NO), the calculating unit 173 extracts the VMID in which the second processing amount is more than the first processing amount and the first processing amount (Operation S161). The calculating unit 173 reads a predetermined condition related to scheduling from the HD 15 (Operation S162). The calculating unit 173 calculates a distribution value corresponding to the extracted VMID by distributing the sum according to predetermined conditions (Operation S163). For example, the distribution value may be calculated on the basis of the weight. When the weight of the VM 21 is 1, the weight of the VM 22 is 3, and the sum is 40, 10 may be distributed to the VM 21, and 30 may be distributed to the VM 22. Alternatively, the sum may be appropriately distributed. For example, the sum may be uniformly distributed.

The calculating unit 173 adds the calculated distribution value to the first processing amount corresponding to the VMID (Operation S164). The calculating unit 173 calculates the addition result as the third processing amount corresponding to the VMID (Operation S165). The calculating unit 173 stores the VMID and the third processing amount in the third file 153. The process proceeds to Operation S177. In addition, the following process may be performed. The calculating unit 173 extracts the VMID in which the first processing amount is more than the second processing amount and the first processing amount. The calculating unit 173 determines the first processing amount related to the extracted VMID as the third processing amount. The calculating unit 173 stores the VMID and the third processing amount in the third file 153.

If it is determined that the sum is equal to or more than the auxiliary sum (Operation S159: YES), the calculating unit 173 extracts the VMID in which the second processing amount is more than the first processing amount and the second processing amount (Operation S171). The calculating unit 173 determines the second processing amount related to the extracted VMID as the third processing amount (Operation S172). The calculating unit 173 stores the VMID and the third processing amount in the third file 153 (Operation S173). The following process may be performed. The calculating unit 173 extracts the VMID in which the first processing amount is more than the second processing amount and the first processing amount. The calculating unit 173 determines the first processing amount related to the extracted VMID as the third processing amount. The calculating unit 173 stores the VMID and the third processing amount in the third file 153.

The calculating unit 173 reads the VMID and the second processing amount from the second file 152 (Operation S177). The calculating unit 173 reads the VMID and the third processing amount from the third file 153 (Operation S178). The calculating unit 173 outputs the read VMID, the second processing amount, and the third processing amount to the determining unit 176 (Operation S179).

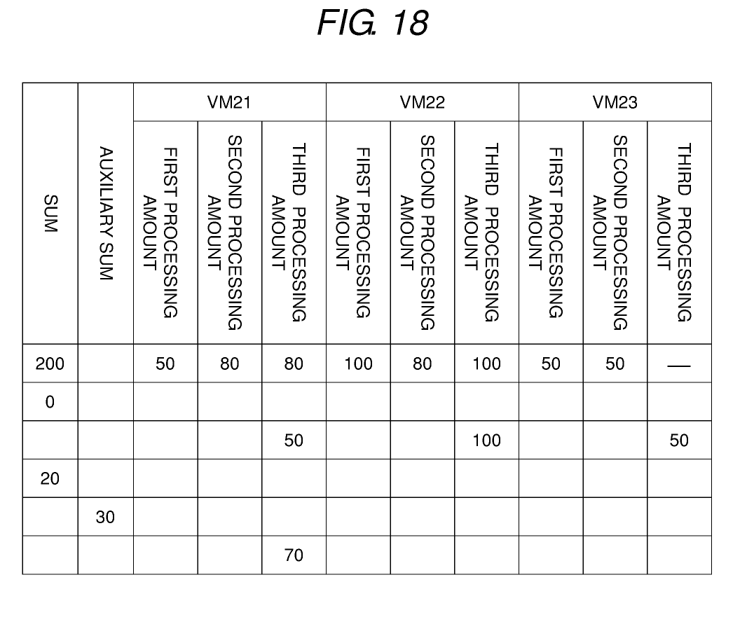

FIG. 18 illustrates an example of the distribution of the third processing amount. FIG. 18 illustrates an example in which the number of CPUs 11 in the physical machine 1 is 2 and the VM 23 starts while two VMs 21 and 22 are being operated. In FIG. 18, the processing amounts and values are written only when they are changed. The sum is 200 on the basis of the maximum first processing amount. The sum (50+100+50) of the first processing amounts of the VMs 2 is subtracted from the maximum first processing amount (200) to calculate a sum of 0 (initial sum).

The third processing amount of each VM 2 is overwritten by the first processing amount. The VM 2 having the first processing amount more than the second processing amount is extracted. In this case, the VM 22 is extracted. The second processing amount (80) is subtracted from the first processing amount (100). The calculated value (20) is added to an initial sum (0) to calculate a sum (20). The VM 2 having the second processing amount more than the first processing amount is extracted. In this case, the VM 21 is extracted. The first processing amount (50) is subtracted from the second processing amount (80). The calculated value is the auxiliary sum (30).

Since the sum (20) is less than the auxiliary sum (30), the VM 2 having the second processing amount more than the first processing amount is extracted. In this case, the VM 21 is extracted. The sum (20) is distributed to the VM 21. The distributed value (20) is added to the first processing amount (50) of the VM 21, and the third processing amount of the VM 21 is 70. The first processing amount (100) of the VM 22 is the third processing amount (100), and the first processing amount (50) of the VM 23 is the third processing amount (50).

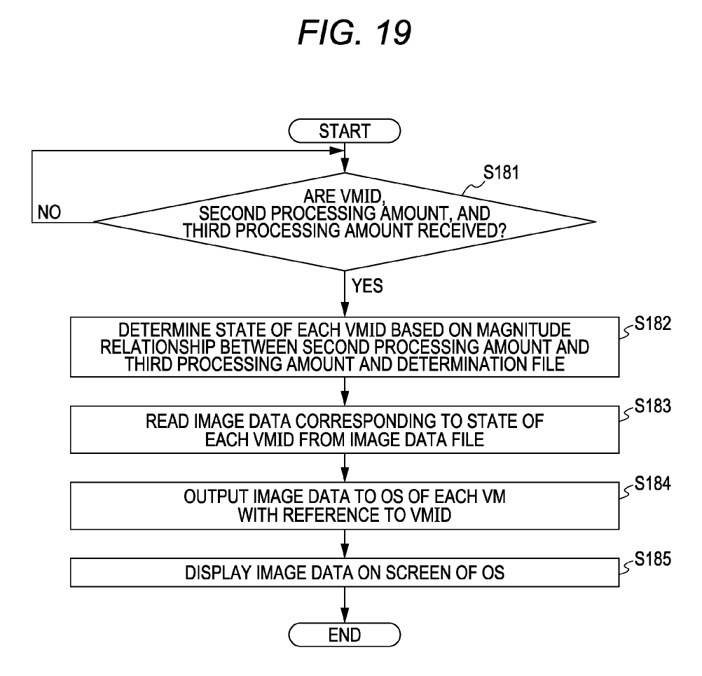

FIG. 19 is a flowchart illustrating the procedure of a state determining process. The determining unit 176 determines whether the VMID, the second processing amount, and the third processing amount output from the calculating unit 173 are received (Operation S181). If it is determined that the VMID, the second processing amount, and the third processing amount are not received (Operation S181: NO), the determining unit 176 repeats the process. If it is determined that the VMID, the second processing amount, and the third processing amount are received (Operation S181: YES), the determining unit 176 determines the state of each VMID on the basis of the magnitude relationship between the second processing amount and the third processing amount and the determination file 157 (Operation S182).

The determining unit 176 reads the image data 344 corresponding to the state of each VMID from the image data file 158 (Operation S183). The determining unit 176 outputs the image data 344 to the OS 211 of each VM 2 with reference to the VMID (Operation S184). The OS 211 receives the image data 344 and displays the image data on the screen of the OS 211, as illustrated in FIG. 9 (Operation S185). In this way, it is possible to appropriately determine the state according to the conditions of the applications 212 executed by each of the VMs 21, 22, 23 . . . , or the operation conditions of the VM 2.

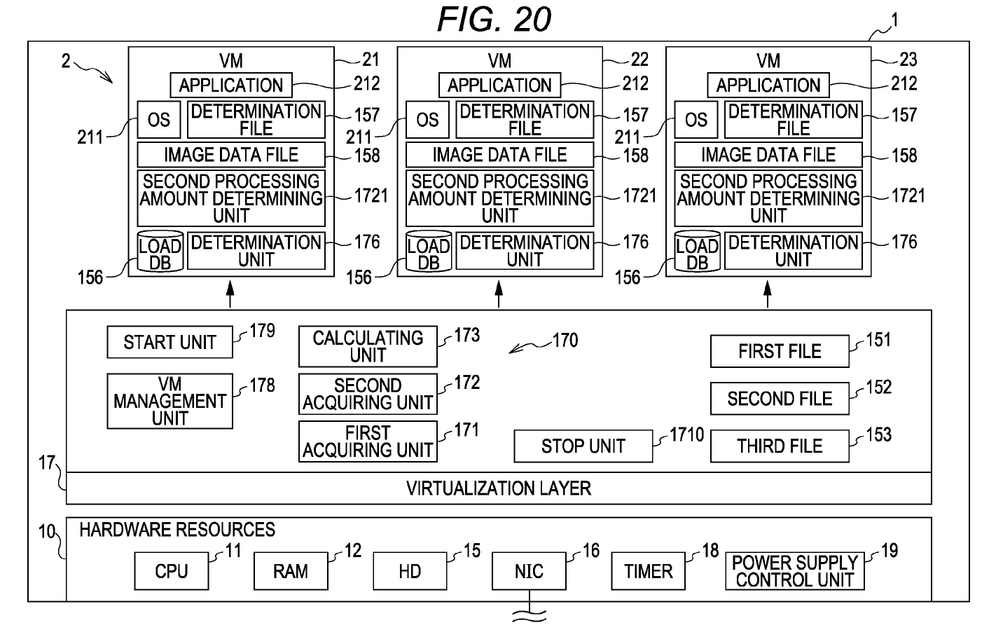

A second embodiment relates to a structure in which some modules 170 are executed by the VM 2. In this embodiment, each process is just an example, and processes related to some modules 170 may be appropriately performed by the VM 2. FIG. 20 illustrates the hardware and software of a physical machine 1 and VMs 2 according to the second embodiment. A load DB 156, a determination file 157, a determining unit 176, and an image data file 158 are provided in each of the VMs 2. A second processing amount determining unit 1721 is newly provided in each of the VMs 2. The second processing amount determining unit 1721 determines the second processing amount with reference to the load DB 156, similar to the second acquiring unit 172 according to the first embodiment. The second processing amount determining unit 1721 outputs the determined second processing amount and the VMID to the second acquiring unit 172.

The second acquiring unit 172 acquires the second processing amount output from the second processing amount determining unit 1721. Similar to the first embodiment, the calculating unit 173 outputs the second processing amount and the third processing amount to a corresponding VM 2. The determining unit 176 determines the state of the VM 2 on the basis of the second processing amount, the third processing amount, and the determination file 157. The determining unit 176 reads image data 344 corresponding to the state from the image data file 158. The determining unit 176 outputs the image data 344 and the VMID to the OS 211. The OS 211 displays the image data 344.

In this embodiment, the determining unit 176, the determination file 157, and the image data file 158 may be provided in the VM 2, and the second processing amount determining unit 1721 and the load DB 156 may not be provided in the VM 2. In this case, similar to the first embodiment, the load DB 156 is provided in the physical machine 1. In addition, in this embodiment, the second processing amount determining unit 1721 and the load DB 156 may be provided in the VM 2, and the determining unit 176, the determination file 157, and the image data file 158 may be provided in the physical machine 1, not the VM 2, similar to the first embodiment. In this way, it is possible to output information in various ways by appropriately distributing the module 170 according to the design.

In the second embodiment, similar components as those in the first embodiment are denoted by the same reference numerals and a detailed description thereof will not be repeated here.

A third embodiment relates to a structure that determines the state of a VM considering all of the first to third processing amounts. The following structure is applied to the first embodiment by way of example, but it may be applied to the second embodiment. The calculating unit 173 outputs the VMID, the first processing amount, the second processing amount, and the third processing amount to the determining unit 176. The determining unit 176 determines the state of each VM on the basis of the magnitude relationship among the first processing amount, the second processing amount, and the third processing amount, and the determination file 157.

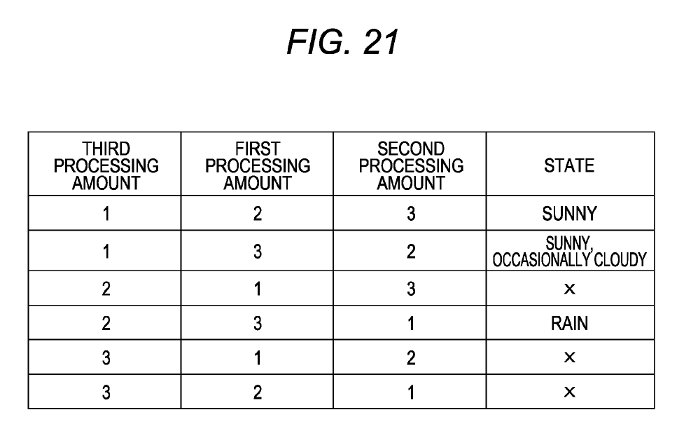

FIG. 21 illustrates the record layout of the determination file 157. The determination file 157 includes, for example, a third processing amount field, a first processing amount field, a second processing amount field, and a state field. Numbers indicating the magnitude relationship among the third processing amount, the first processing amount, and the second processing amount are stored in the third processing amount field, the first processing amount field, and the second processing amount field, respectively. The numbers written in the third processing amount field, the first processing amount field, and the second processing amount field illustrated in FIG. 21 indicate the order of the processing amounts when the processing amounts are arranged in descending order. That is, as the number is decreased, ranking is high and the value of the processing amount is increased. Information indicating the state of the hardware resources 10 of the VM 2 is stored in the state field. For example, when the third processing amount is the largest, followed by the first processing amount and the second processing amount, a state ‘sunny’ is read on the basis of ‘1 ’ (rank) in the third processing amount field, ‘2 ’ (rank) in the first processing amount field, and ‘3 ’ (rank) in the second processing amount field.

In addition, ‘X’ written in the state field indicates that the first processing amount is more than the third processing amount. As described above, when there is no related combination, X is written, which is similar with the following embodiments. When the state is ‘sunny’, the third processing amount is the largest, followed by the first processing amount and the second processing amount. Since the second processing amount is less than the first processing amount, the CPU usage rate used by the application 212 is lower than the CPU usage rate to be reliably allocated and the application 212 can be comfortably used. Therefore, the state is ‘sunny’.

When the state is ‘sunny with occasional cloudy’, the third processing amount is the largest, followed by the second processing amount and the first processing amount. Since the third processing amount is more than the second processing amount, the state is ‘sunny’. However, since the first processing amount is less than the second processing amount, the third processing amount of another VM 2 is likely to vary. Therefore, the final state is ‘sunny with occasional cloudy’. When the state is ‘rain’, the second processing amount is the largest, followed by the third processing amount and the first processing amount. Since the second processing amount used by the VM 2 is more than the third processing amount, the process of the application 212 is likely to be delayed. Therefore, the state is ‘rain’.

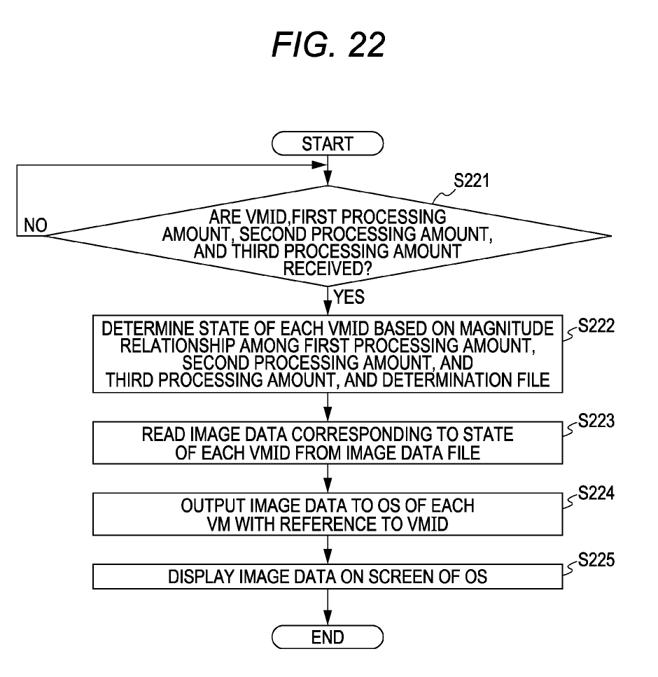

FIG. 22 is a flowchart illustrating the procedure of a state determining process. The determining unit 176 determines whether the VMID, the first processing amount, the second processing amount, and the third processing amount output from the calculating unit 173 are received (Operation S221). If it is determined that the VMID, the first processing amount, the second processing amount, and the third processing amount are not received (Operation S221: NO), the determining unit 176 repeats the process. If it is determined that the VMID, the first processing amount, the second processing amount, and the third processing amount are received (Operation S221: YES), the determining unit 176 determines the state of each VMID on the basis of the magnitude relationship among the first processing amount, the second processing amount, and the third processing amount and the determination file 157 (Operation S222).

The determining unit 176 reads image data 344 corresponding to the state of each VMID from the image data file 158 (Operation S223). The determining unit 176 outputs the image data 344 to the OS 211 of each VM 2 with reference to the VMID (Operation S224). The OS 211 receives the image data 344 and displays the image data on the screen of the OS 211, as illustrated in FIG. 9 (Operation S225). In this way, it is possible to provide a detailed state to the user by considering the first processing amount related to the allocation of the hardware resources 10.

The third embodiment is similar to the first and second embodiments except for the above-mentioned structure. Therefore, in the third embodiment, similar components as those in the first and embodiments are denoted by the same reference numerals and a detailed description thereof will not be repeated here.

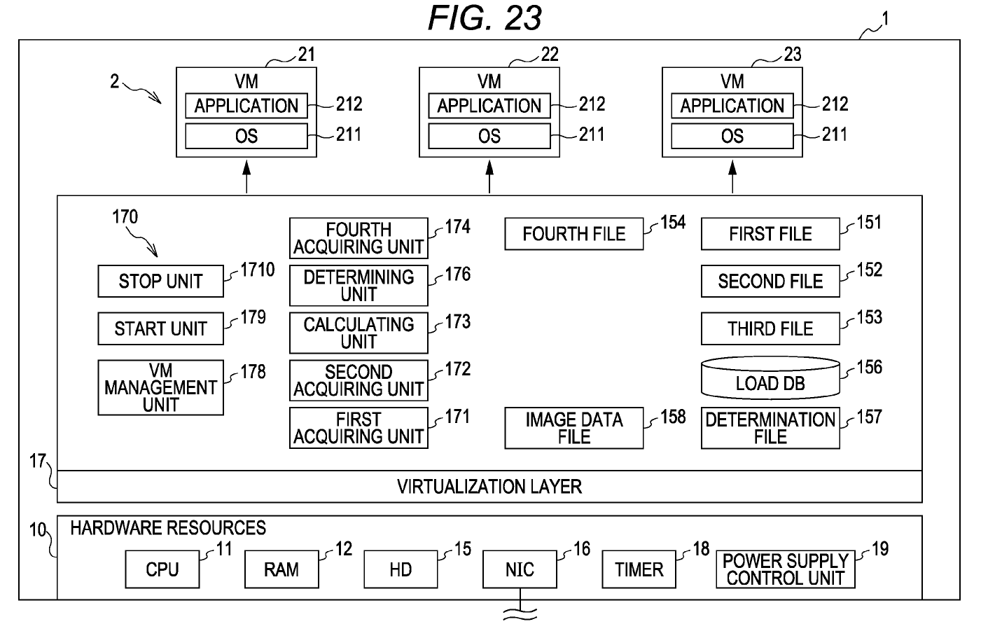

A fourth embodiment relates to a structure that determines the state of each VM considering a fourth processing amount. FIG. 23 illustrates the hardware and software of a physical machine 1 and VMs 2 according to the fourth embodiment. A fourth acquiring unit 174 and a fourth file 154 are additionally provided. The fourth acquiring unit 174 acquires the fourth processing amount indicating the ratio of the amount of resource of the CPU 11 consumed by each VM 2. For example, the current CPU usage rate of the VM 21 is used as the fourth processing amount. Alternatively, the occupancy of the VM 21 in the NIC 16 per unit time or the occupancy of the VM 21 in the HD 15 per unit time may be used as the fourth processing amount. In this embodiment, for example, the CPU usage rate of the VM 21 is used as the fourth processing amount.

The fourth acquiring unit 174 acquires the VMID and the fourth processing amount output from the OS 211 of each VM 2. The fourth acquiring unit 174 stores the VMID and the fourth processing amount in the fourth file 154. In addition, the fourth acquiring unit 174 outputs the VMID and the fourth processing amount to the determining unit 176. The fourth acquiring unit 174 outputs the fourth processing amount output from the OS 211 to the determining unit 176 in real time. Alternatively, the fourth acquiring unit 174 may output the fourth processing amount at a predetermined time interval. In addition, the fourth acquiring unit 174 may output the average of the fourth processing amount within a predetermined time as the fourth processing amount to the determining unit 176 and the fourth file 154. The virtualization layer 17 may acquire the CPU usage rate of each VM 2. The CPU usage rate of each VM 2 is calculated on the basis of the amount of resource of the CPU 11 allocated to each VM 2 by a scheduler (not illustrated) in the virtualization layer 17 for a predetermined time. In this embodiment, the fourth processing amount is output in real time by way of example.

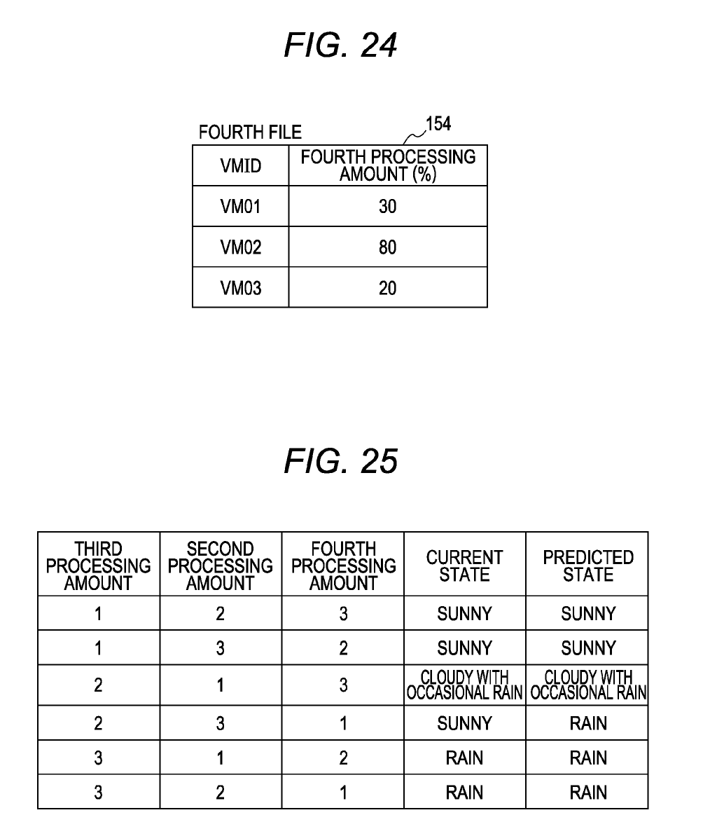

FIG. 24 illustrates the record layout of the fourth file 154. The fourth acquiring unit 174 stores the fourth processing amount of each VM 2 output from the OS 211 in the fourth file 154. The fourth file 154 includes, for example, a VMID field and a fourth processing amount field. The VMID is stored in the VMID field, and the fourth processing amount is stored in the fourth processing amount field so as to be associated with the VMID.

The determining unit 176 determines the state of each VM on the basis of the VMID and the fourth processing amount output from the fourth acquiring unit 174 or the fourth file 154, and the magnitude relationship between the second processing amount and the third processing amount output from the calculating unit 173. In this case, the determining unit 176 also determines the current state and a state predicted to follow the current state (hereinafter, referred to as a predicted state) with reference to the determination file 157. In the following description, the current state contrasted with the predicted state is referred to as a current state.

FIG. 25 illustrates the record layout of the determination file 157. The determination file 157 includes, for example, a third processing amount field, a second processing amount field, a fourth processing amount field, a current state field, and a predicted state field. Numbers indicating the magnitude relationship among the third processing amount, the second processing amount, and the fourth processing amount are stored in the third processing amount field, the second processing amount field, and the fourth processing amount field, respectively. The numbers written in the third processing amount field, the second processing amount field, and the fourth processing amount field illustrated in FIG. 25 indicate the order of the processing amounts when the processing amounts are arranged in descending order. That is, as the number is decreased, ranking is high and the value of the processing amount is increased. Information indicating the current state of the hardware resources 10 of the VM 2 is stored in the current state field. Information indicating a state that is predicted to be arranged after the current state of the hardware resources 10 of the VM 2 in time series is stored in the predicted state field. For example, when the third processing amount is the largest, followed by the second processing amount and the fourth processing amount, the current state ‘sunny’ is read on the basis of ‘1 ’ (rank) in the third processing amount field, ‘2 ’ (rank) in the second processing amount field, and ‘3 ’ (rank) in the fourth processing amount field. In addition, the predicted state ‘sunny’ is read.

Similar to FIG. 8, when the third processing amount is more than the second processing amount, the current state is ‘sunny’. The current states of the first, second, and fourth rows are ‘sunny’. In addition, similar to FIG. 8, when the third processing amount is less than the second processing amount, the current state is ‘rain’. However, when the current fourth processing amount is also considered and the fourth processing amount is less than the third processing amount, the state is not ‘rain’ in the usage environment of the VM 2, but the state is ‘cloudy with occasional rain’. Therefore, the current state of the third row is ‘cloudy with occasional rain’, and the current states of the fifth and sixth rows are ‘rain’.

When the second processing amount is changed to the current fourth processing amount, the predicted state is determined on the basis of a change of the state. In the first, third, and fifth rows, since the second processing amount is more than the fourth processing amount, the predicted state is the same as the current state. In the second row, the second processing amount and the fourth processing amount change their ranks. Therefore, the second row is changed to the first row, and the predicted state is ‘sunny’. In the fourth row, the second processing amount is 1, the fourth processing amount is 2, and the third processing amount is 3. Therefore, the fourth row is changed to the fifth row, and the predicted state is ‘rain’. In the sixth row, the second processing amount and the fourth processing amount change their ranks. Therefore, the sixth row is changed to the fifth row, and the predicted state is ‘rain’.

When the second processing amount is not updated, that is, when the load amount of each application in the load DB 156 is not updated, the current state of the fourth row is ‘sunny’ and the predicted state thereof is ‘rain’. Therefore, when the second processing amount is not updated and the previous predicted state is not identical to the current state, the current state is the predicted state, and it is possible to prevent the state from being maintained to be ‘sunny’. That is, in this case, both of the current state and the predicted state are ‘rain’.

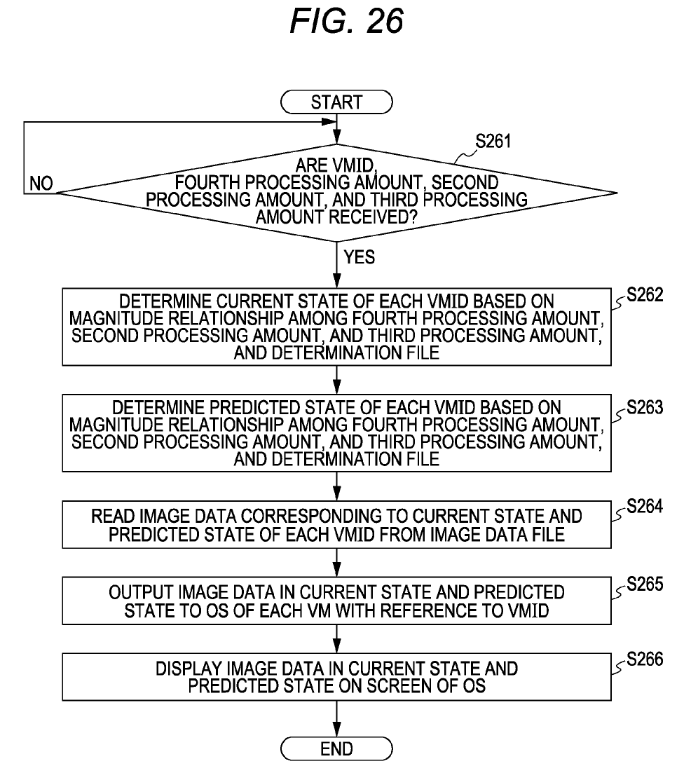

FIG. 26 is a flowchart illustrating the procedure of a state determining process. The determining unit 176 determines whether the VMID, the fourth processing amount, the second processing amount, and the third processing amount output from the calculating unit 173 and the fourth acquiring unit 174 are received (Operation S261). If it is determined that the VMID, the fourth processing amount, the second processing amount, and the third processing amount are not received (Operation S261: NO), the determining unit 176 repeats the process. If it is determined that the VMID, the fourth processing amount, the second processing amount, and the third processing amount are received (Operation S261: YES), the determining unit 176 determines the current state of each VMID on the basis of the magnitude relationship among the fourth processing amount, the second processing amount, and the third processing amount and the determination file 157 (Operation S262).

In addition, the determining unit 176 determines the predicted state of each VMID on the basis of the magnitude relationship among the fourth processing amount, the second processing amount, and the third processing amount and the determination file 157 (Operation S263). The determining unit 176 reads image data 344 corresponding to the current state and the predicted state of each VMID from the image data file 158 (Operation S264). The determining unit 176 outputs the image data 344 in the current state and the predicted state to the OS 211 of each VM 2 with reference to the VMID (Operation S265). The OS 211 receives the image data 344 in the current state and the predicted state and displays the image data on the screen of the OS 211 (Operation S266).

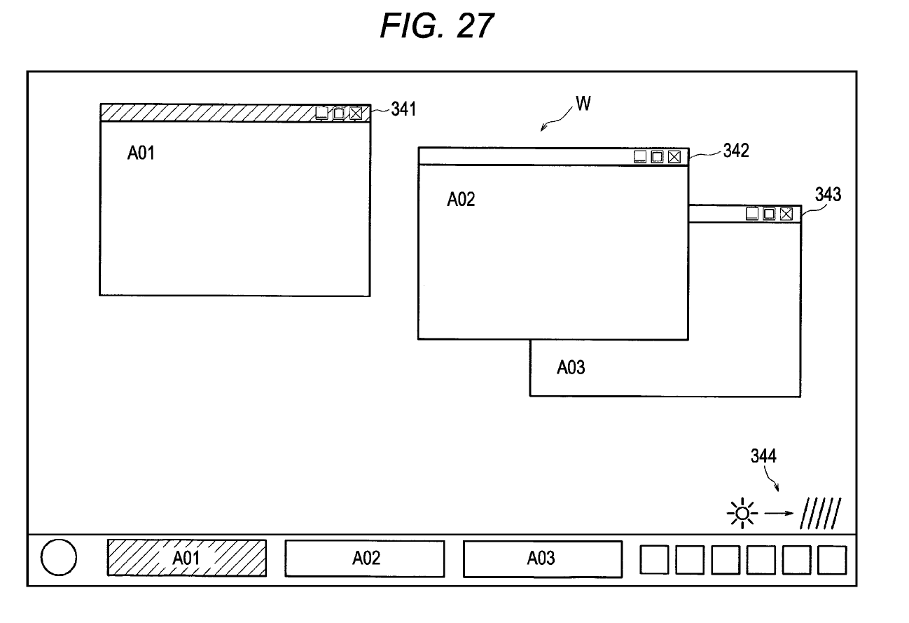

FIG. 27 illustrates the image of the state displayed on the display unit of the computer 3. The image data 344 that enables the user to easily view the current state (sunny) and the predicted state (rain) is displayed on the desktop. It is preferable that an image indicating the temporal order, such as an arrow from the current state to the predicted state, be described between the image of the current state and the image of the predicted state such that the current state precedes the predicted state in time series. In addition, image data indicating the temporal order is also stored in the image data file 158, similar to the image data 344 corresponding to the state. In this way, it is possible to provide a predicted future state as well as the current state to the user by considering the fourth processing amount related to the ratio of the consumption amount of hardware resource 10.

In the fourth embodiment, similar components as those in the first to third embodiments are denoted by the same reference numerals and a detailed description thereof will not be repeated here.

A fifth embodiment relates to a structure that considers all of the first to fourth processing amounts. The calculating unit 173 outputs the first to third processing amounts to the determining unit 176. The fourth acquiring unit 174 outputs the fourth processing amount to the determining unit 176. The determining unit 176 determines the current state and the predicted state on the basis of the magnitude relationship among the first to fourth processing amounts and the determination file 157.

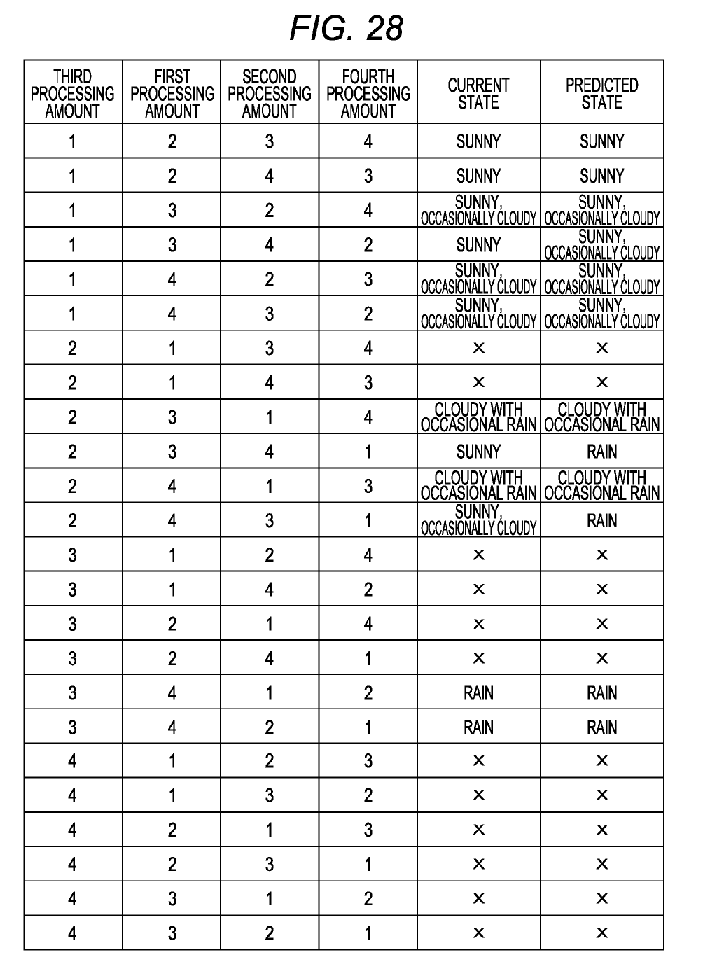

FIG. 28 illustrates the record layout of the determination file 157. The determination file 157 includes, for example, a third processing amount field, a first processing amount field, a second processing amount field, a fourth processing amount field, a current state field, and a predicted state field. Numbers indicating the magnitude relationship among the third processing amount, the first processing amount, the second processing amount, and the fourth processing amount are stored in the third processing amount field, the first processing amount field, the second processing amount field, and the fourth processing amount field, respectively. The numbers written in the third processing amount field, the first processing amount field, the second processing amount field, and the fourth processing amount field illustrated in FIG. 28 indicate the order of the processing amounts when the processing amounts are arranged in descending order. That is, as the number is decreased, ranking is high and the value of the processing amount is increased.

Information indicating the current state of the hardware resources 10 of the VM 2 is stored in the current state field. Information indicating a state that is predicted to be arranged after the current state of the hardware resources 10 of the VM 2 in time series is stored in the predicted state field. For example, when the third processing amount is the largest, followed by the first processing amount, the second processing amount, and the fourth processing amount in this order, the current state ‘sunny’ is read on the basis of ‘1 ’ (rank) in the third processing amount field, ‘2 ’ (rank) in the first processing amount field, ‘3 ’ (rank) in the second processing amount field, and ‘4 ’ (rank) in the fourth processing amount field. In addition, the predicted state ‘sunny’ is read.

It may be assumed that, when the third processing amount is the largest, followed by the first processing amount and the second processing amount, the current state is ‘sunny’, as illustrated in FIG. 21. Therefore, the current states of the first, second, fourth, and tenth rows are ‘sunny’. It may be assumed that, when the third processing amount is the largest, followed by the second processing amount and the first processing amount, the current state is ‘sunny with occasional cloudy’, as illustrated in FIG. 21. Therefore, the current states of the third, fifth, sixth, and twelfth rows are ‘sunny with occasional cloudy’. In addition, it may be premised that, when the second processing amount is the largest, followed by the third processing amount and the first processing amount, the current state is ‘rain’, as illustrated in FIG. 21. However, in this embodiment, the fourth processing amount is also considered. Therefore, when the fourth processing amount is less than the third processing amount, the current state is ‘cloudy with occasional rain’ in order to indicate that the current state does not become ‘rain’ in the use of the VM 2. In the other cases, the current state is ‘rain’.

Therefore, the current states of the ninth and eleventh rows are ‘cloudy with occasional rain’, and the current state of the seventeenth and eighteenth rows are ‘rain’. When the second processing amount is changed relative the fourth processing amount, the predicted state is determined on the basis of a change of the state. In the first, third, fifth, ninth, eleventh, and seventeenth rows, since the second processing amount is more than the fourth processing amount, the predicted state is the same as the current state. In the second row, the second processing amount and the fourth processing amount change their ranks. Therefore, the second row is changed to the first row, and the predicted state is ‘sunny’. In the fourth row, the third processing amount is the largest, followed by the second processing amount, the fourth processing amount, and the first processing amount in this order. Therefore, the fourth row is changed to the fifth row, and the predicted state is ‘sunny with occasional cloudy’.

In the sixth row, the second processing amount and the fourth processing amount change their ranks. Therefore, the sixth row is changed to the fifth row, and the predicted state is ‘sunny with occasional cloudy’. In the tenth row, the second processing amount is the largest, followed by the fourth processing amount, the third processing amount, and the first processing amount in this order. Therefore, the tenth row is changed to the seventeenth row, and the predicted state is ‘rain’. In the twelfth row, the second processing amount is the largest, followed by the fourth processing amount, the third processing amount, and the first processing amount. Therefore, the twelfth row is changed to the seventeenth row, and the predicted state is ‘rain’. In the eighteenth row, the second processing amount and the fourth processing amount change their ranks. Therefore, the eighteenth row is changed to the seventeenth row, and the predicted state is ‘rain’. Similar to FIG. 25, when the second processing amount is not updated, the fourth, tenth, and twelfth rows are not changed to the predicted state. Therefore, when the previous predicted state is not identical to the current state, the current state becomes the predicted state. The above-mentioned ranking is just an illustrative example, and it may be appropriately changed. The operator may use the computer 3 to appropriately change the content of the determination file 157.

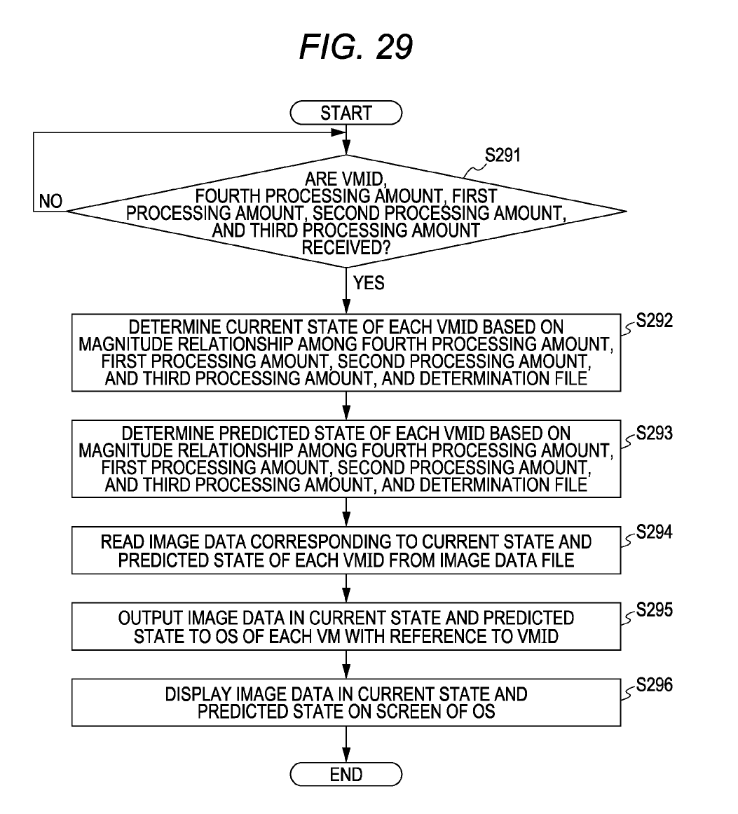

FIG. 29 is a flowchart illustrating the procedure of a state determining process. The determining unit 176 determines whether the VMID, the fourth processing amount, the first processing amount, the second processing amount, and the third processing amount output from the calculating unit 173 and the fourth acquiring unit 174 are received (Operation S291). If it is determined that the VMID, the fourth processing amount, the first processing amount, the second processing amount, and the third processing amount are not received (Operation S291: NO), the determining unit 176 repeats the process. If it is determined that the VMID, the fourth processing amount, the first processing amount, the second processing amount, and the third processing amount are received (Operation S291: YES), the determining unit 176 determines the current state of each VMID on the basis of the magnitude relationship among the fourth processing amount, the first processing amount, the second processing amount, and the third processing amount and the determination file 157 (Operation S292).

In addition, the determining unit 176 determines the predicted state of each VMID on the basis of the magnitude relationship among the fourth processing amount, the first processing amount, the second processing amount, and the third processing amount and the determination file 157 (Operation S293). The determining unit 176 reads image data 344 corresponding to the current state and the predicted state of each VMID from the image data file 158 (Operation S294). The determining unit 176 outputs the image data 344 in the current state and the predicted state to the OS 211 of each VM 2 with reference to the VMID (Operation S295). The OS 211 receives the image data 344 in the current state and the predicted state and displays the image data on the screen of the OS 211 (Operation S296). In this way, it is possible to provide the predicted future state as well as the current state to the user by considering both the fourth processing amount related to the ratio of the consumption amount of hardware resources 10 and the first processing amount related to the allocation of the hardware resources 10.

In the fifth embodiment, similar components as those in the first to fourth embodiments are denoted by the same reference numerals and a detailed description thereof will not be repeated here.

A sixth embodiment relates to a structure that determines the second processing amount on the basis of the load amount and the fourth processing amount. The second acquiring unit 172 acquires a load amount corresponding to the selected application ID described in the first embodiment from the load DB 156. The second acquiring unit 172 acquires the fourth processing amount from the fourth acquiring unit 174. The second acquiring unit 172 compares the fourth processing amount with the second processing amount to determine the second processing amount.

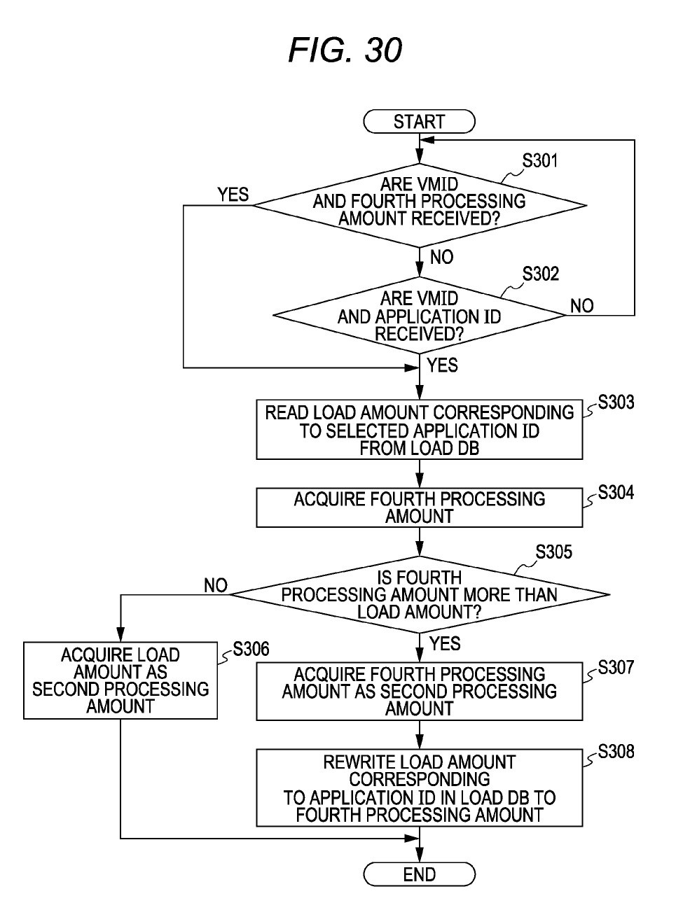

FIG. 30 illustrates acquiring the second processing amount. The second acquiring unit 172 determines whether the VMID and the fourth processing amount output from the fourth acquiring unit 174 are received (Operation S301). If it is determined that the VMID and the fourth processing amount output from the fourth acquiring unit 174 are not received (Operation S301: NO), the second acquiring unit 172 determines whether the VMID and the application ID are received from the OS 211 (Operation S302). As described in the first embodiment, the application ID of the selected application 212 among the applications 212 that are being executed is output from the OS 211 to the second acquiring unit 172.

If it is determined that the VMID and the application ID are not received (Operation S302: NO), the second acquiring unit 172 returns the process to Operation S301. If it is determined that the VMID and the fourth processing amount are received (Operation S301: YES), or if it is determined that the VMID and the application ID are received (Operation S302: YES), the second acquiring unit 172 proceeds to Operation S303. The second acquiring unit 172 reads a load amount corresponding to the application ID of the selected application from the load DB 156 (Operation S303).

The second acquiring unit 172 acquires the fourth processing amount output from the fourth acquiring unit 174 (Operation S304). The second acquiring unit 172 determines whether the fourth processing amount is more than the load amount (Operation S305). If it is determined that the fourth processing amount is not more than the load amount (Operation S305: NO), the second acquiring unit 172 acquires the currently selected load amount read in Operation S303 as the second processing amount (Operation S306). On the other hand, if it is determined that the fourth processing amount is more than the load amount (Operation S305: YES), the second acquiring unit 172 acquires the fourth processing amount acquired in Operation S304 as the second processing amount (Operation S307).

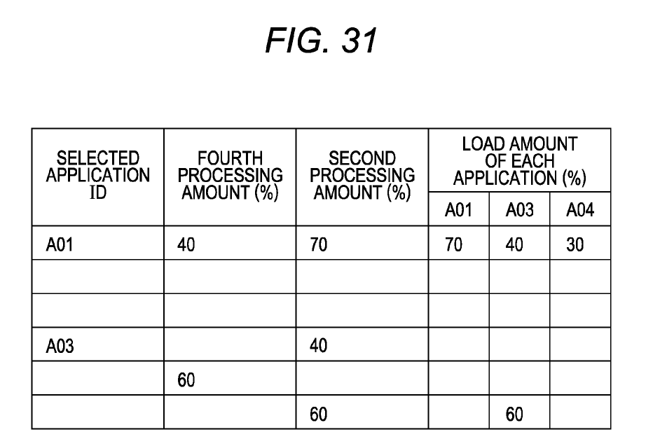

The second acquiring unit 172 rewrites a load amount corresponding to the application ID of Operation S303 in the load DB 156 to the fourth processing amount (Operation S308). The second processing amount acquired in Operation S306 and Operation S307 is output to the calculating unit 173 in order to calculate the third processing amount. FIG. 31 illustrates the transition of the second processing amount. As illustrated in the first row, at the beginning, an application 212 with an application ID ‘A01’ is selected. It is assumed that the load amount of the selected application 212 is ‘70’ and the second processing amount is ‘70’. Since a fourth processing amount ‘40’ is not more than the second processing amount ‘70’, the second processing amount ‘70’ is maintained. Then, an application 212 with an application ID ‘A03’ is selected.

The load amount of the application with the application ID ‘A03’ is ‘40’ and the second acquiring unit 172 acquires the load amount ‘40’ as the second processing amount. It is assumed that the load is increased according to the conditions of the application 212 executed by the VM 2. In this case, a fourth processing amount ‘60’ is output from the fourth acquiring unit 174 to the second acquiring unit 172. The second acquiring unit 172 determines whether the fourth processing amount is more than the second processing amount. In this example, the fourth processing amount ‘60’ is more than the second processing amount ‘40’. In this case, the second acquiring unit 172 acquires the fourth processing amount ‘60’ as the second processing amount ‘60’. In addition, it is assumed that the load amount of the corresponding application with the application ID ‘A03 ’ is ‘60’ which is equal to the fourth processing amount. The load amount of each application 212 is increased. However, when the VM 2 stops, the load amount may be reset to the initial load amount illustrated in FIG. 4. In this way, when the fourth processing amount is more than the load amount of the application 212 that is being executed, it is possible to appropriately determine the state of each VM by appropriately changing the second processing amount.

In the sixth embodiment, similar components as those in the first to fifth embodiments are denoted by the same reference numerals and a detailed description thereof will not be repeated here.

A seventh embodiment relates to a structure that determines the second processing amount on the basis of a plurality of applications 212 executed by the VM 2. When a plurality of applications 212 is being executed, the second acquiring unit 172 may acquire the sum of a plurality of load amounts or the average value of a plurality of load amounts as the second processing amount. Alternatively, the second acquiring unit 172 may acquire a value obtained by multiplying the sum of the load amounts or the average value of the load amounts by a predetermined coefficient as the second processing amount. This embodiment relates to a structure in which the sum of a plurality of load amounts is acquired as the second processing amount.

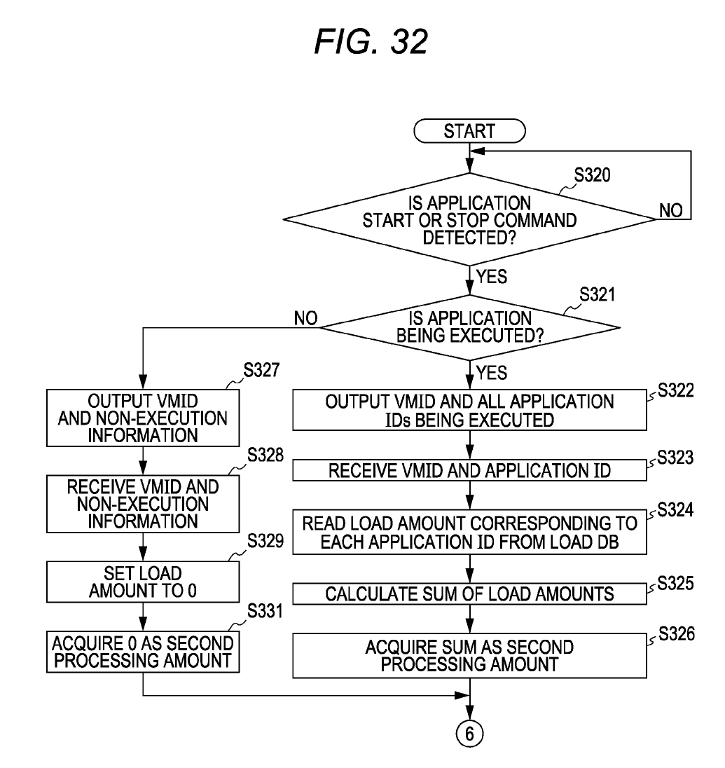

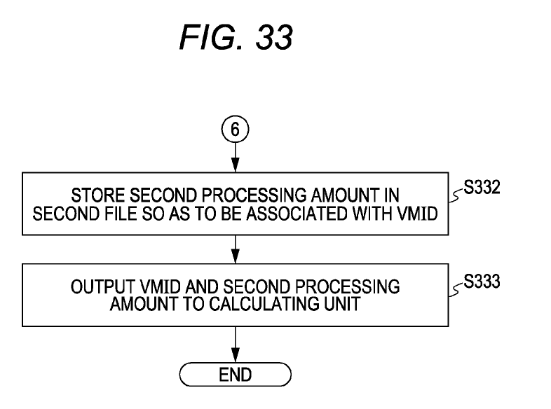

FIGS. 32 and 33 are flowcharts illustrating the procedure of a process of acquiring the second processing amount. The following process is performed on each VM 2 in parallel. The OS 211 determines whether a start or stop command for the application 212 is detected from the computer 3 (Operation S320). If it is determined that a start or stop command for the application 212 is not detected from the computer 3 (Operation S320: NO), the OS 211 repeats the above-mentioned process. If it is determined that a start or stop command for the application 212 is detected from the computer 3 (Operation S320: YES), the OS 211 determines whether at least one application 212 is executed (Operation S321). In addition, in Operation S321, the OS 211 may determine whether at least one application 212 corresponding to the application ID stored in the load DB 156 starts up. For example, when a time display application 212 that certainly starts up every time when the system starts up or a calculator application 212 with a small load starts up, the determination result of Operation S320 may be ‘NO’.

If it is determined that the application 212 is being executed (Operation S321: YES), the OS 211 outputs the VMID and the application IDs of all the applications that are being executed to the second acquiring unit 172 (Operation S322). The second acquiring unit 172 receives the VMID and the application IDs of all the applications output from the OS 211 (Operation S323). The second acquiring unit 172 reads a load amount corresponding to each of the application IDs from the load DB 156 (Operation S324). The second acquiring unit 172 adds the read load amounts to calculate the sum thereof (Operation S325). When a plurality of windows W is starts up in the same application 212, the OS 211 outputs the application ID and the number of windows W in Operation S322. In this case, the second acquiring unit 172 may acquire a value obtained by multiplying the read load amount corresponding to the application ID by the number of windows W as the load amount of the application 212. Alternatively, the second acquiring unit 172 may add a value obtained by subtracting 1 from the number of windows W and a value obtained by multiplying the read load amount by a predetermined coefficient smaller than 1 to the read load amount corresponding to the application ID, and acquires the calculated value as the load amount of the application 212.

The second acquiring unit 172 acquires the calculated sum as the second processing amount (Operation S326). If it is determined that no application 212 is being executed (Operation S321: NO), the OS 211 outputs the VMID and non-execution information to the second acquiring unit 172 (Operation S327). The second acquiring unit 172 receives the VMID and the non-execution information (Operation S328). The second acquiring unit 172 sets the load amount to 0 (Operation S329). The second acquiring unit 172 acquires the load amount 0 as the second processing amount (Operation S331). After Operation S331 and Operation S326, the process proceeds to Operation S332.

The second acquiring unit 172 stores the second processing amount in the second file 152 so as to be associated with the VMID (Operation S332). The second acquiring unit 172 outputs the VMID and the second processing amount to the calculating unit 173 in order to calculate the third processing amount (Operation S333). In this way, it is possible to determine a state corresponding to the number of applications 212 that are being executed and thus provide the detailed state of each VM 2 to the user.

In the seventh embodiment, similar components as those in the first to sixth embodiments are denoted by the same reference numerals and a detailed description thereof will not be repeated here.

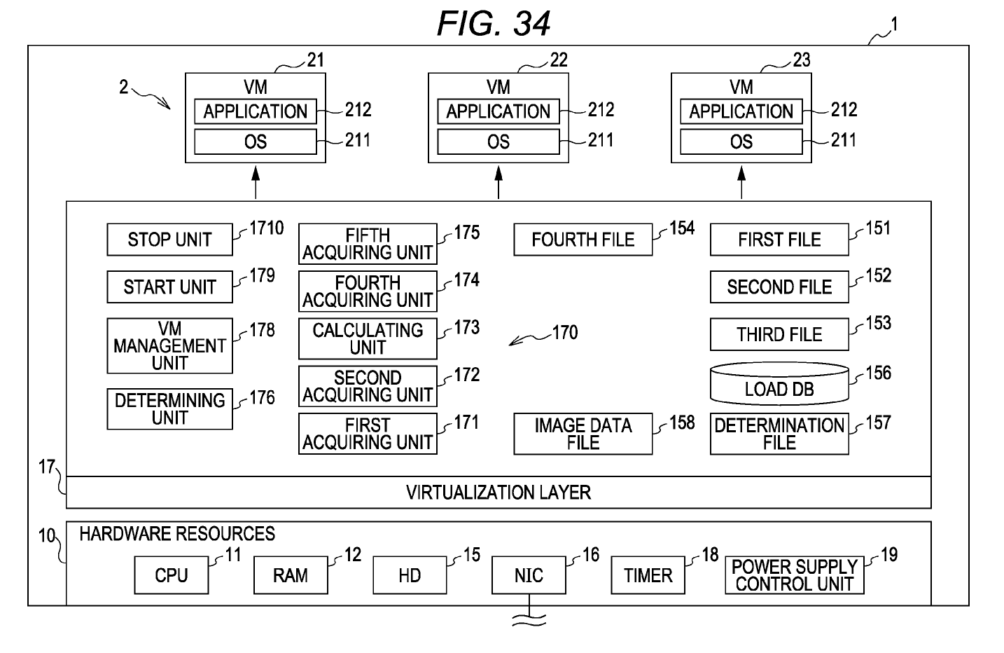

An eighth embodiment relates to a structure that acquires the second processing amount considering a fifth processing amount. FIG. 34 illustrates the hardware and software of a physical machine 1 and VMs 2 according to the eighth embodiment. The OS 211 acquires the fifth processing amount indicating the ratio of the amount of hardware resource 10 consumed by each application 212 that is being executed. For example, the CPU usage rate of each application 212, the occupancy of each application 212 in the HD 15 per unit time, or the occupancy of each application 211 in the NIC 16 per unit time is used as the fifth processing amount. In the case of Windows (registered trademark), for example, the CPU usage rate of each application 212 may be acquired by a task manager.

The occupancy of each application 212 in the HD 15 per unit time may be acquired by analyzing the access frequency of each application 212 to the HD 15. In addition, the occupancy of each application 212 in the NIC 16 per unit time may be acquired on the basis of, for example, the amount of data transmitted or received per unit time. In this embodiment, the CPU usage rate of each application 212 is used as the fifth processing amount. The OS 211 outputs the VMID, the application ID, and the fifth processing amount to the fifth acquiring unit 175. The fifth acquiring unit 175 outputs the VMID, the application ID, and the fifth processing amount to the second acquiring unit 172. The second acquiring unit 172 acquires the second processing amount on the basis of the VMID, the application ID, the fifth processing amount, and the load amount.

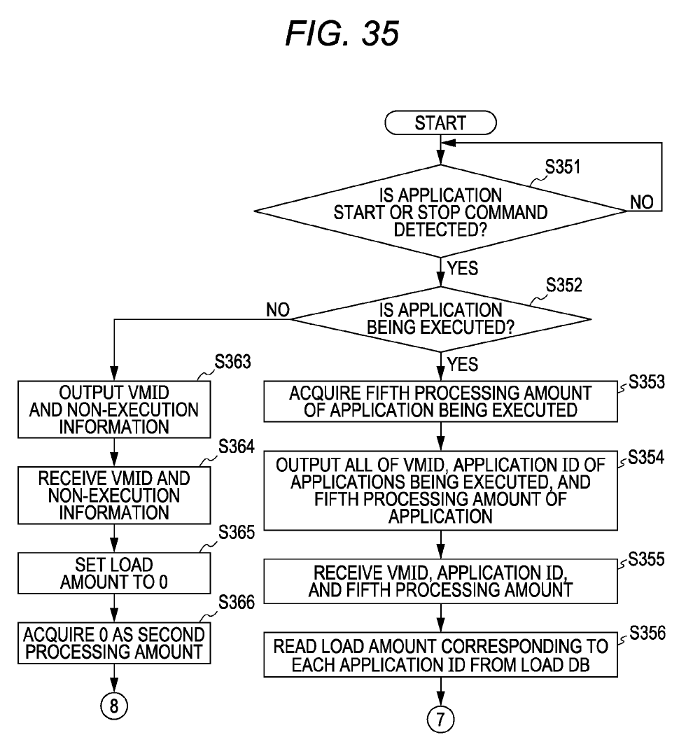

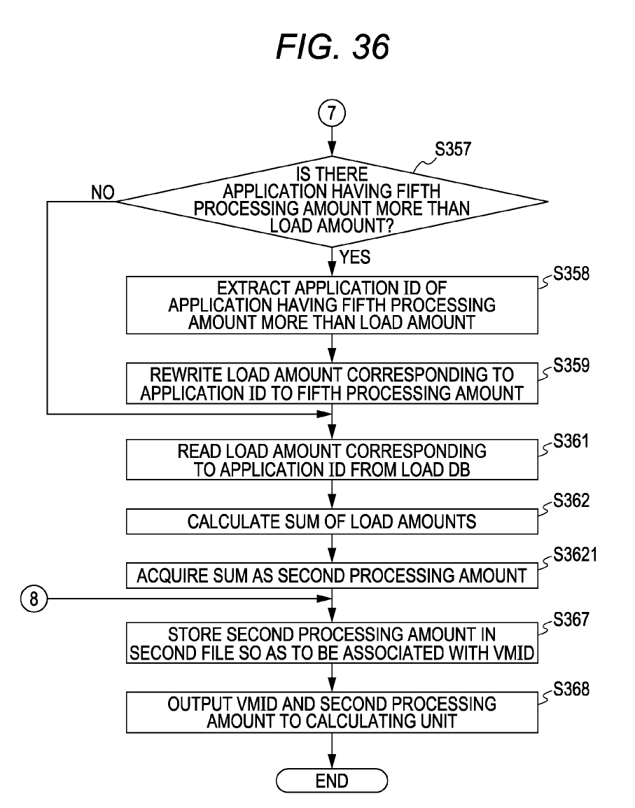

FIGS. 35 and 36 illustrate a process of acquiring the second processing amount. The following process is performed on each VM 2 in parallel. The OS 211 determines whether a start or stop command for the application 212 is detected from the computer 3 (Operation S351). If it is determined that a start or stop command for the application 212 is not detected from the computer 3 (Operation S351: NO), the OS 211 repeats the above-mentioned process. If it is determined that a start or stop command for the application 212 is detected from the computer 3 (Operation S351: YES), the OS 211 determines whether at least one application 212 is executed (Operation S352).

If it is determined that at least one application 212 is executed (Operation S352: YES), the OS 211 acquires the fifth processing amounts of all the applications 212 that are being executed (Operation S353). The OS 211 outputs all of the VMID, the application IDs of the applications 212 being executed, and the fifth processing amounts of the applications 212 to the fifth acquiring unit 175 (Operation S354). The fifth acquiring unit 175 acquires the fifth processing amounts. The fifth acquiring unit 175 outputs the acquired VMID, application IDs, and fifth processing amounts to the second acquiring unit 172.

The second acquiring unit 172 receives the VMID, the application IDs, and fifth processing amounts output from the fifth acquiring unit 175 (Operation S355). The second acquiring unit 172 reads a load amount corresponding to each application ID from the load DB 156 (Operation S356). The second acquiring unit 172 determines whether there is an application 212 in which the fifth processing amount of the application 212 received in Operation S355 is more than the load amount corresponding to the application 212 read in Operation S356 (Operation S357).

If it is determined that there is an application 212 having the fifth processing amount more than the load amount (Operation S357: YES), the second acquiring unit 172 extracts the application ID of the application 212 having the fifth processing amount more than the load amount (Operation S358). The second acquiring unit 172 rewrites a load amount corresponding to the application ID in the load DB 156 to the fifth processing amount (Operation S359). The content of the load DB 156 is rewritten. However, when the VM 2 stops, the load amount may return to the initial load amount illustrated in FIG. 4.

If it is determined that there is no application 212 having the fifth processing amount more than the load amount (Operation S357: NO), or after Operation S359, the second acquiring unit 172 proceeds to Operation S361. The second acquiring unit 172 reads a load amount corresponding to each application ID from the load DB 156 (Operation S361). The second acquiring unit 172 adds the read load amounts to calculate the sum thereof (Operation S362).

The second acquiring unit 172 acquires the calculated sum as the second processing amount (Operation S3621). In this embodiment, the calculation of the sum is just an illustrative example, but the invention is not limited thereto. Any other acquiring processes may be used as long as the second processing amount is caused by a plurality of applications 212 that is being operated. For example, the second acquiring unit 172 may acquire the average value of a plurality of read load amounts as the second processing amount. The second acquiring unit 172 may acquire a value obtained by multiplying the sum or the average value of a plurality of read load amounts by a predetermined coefficient as the second processing amount. Further, weights may be set so as to be associated with the applications 212, the load amount of each application 212 may be multiplied by the weight of each application 212, and the sum of the load amounts of the applications 212 that are multiplied by the weights may be acquired as the second processing amount.

If it is determined that no application 212 is being executed (Operation S352: NO), the OS 211 outputs the VMID and the non-execution information to the second acquiring unit 172 (Operation S363). The second acquiring unit 172 receives the VMID and the non-execution information (Operation S364). The second acquiring unit 172 sets the load amount to 0 (Operation S365). The second acquiring unit 172 acquires the load amount 0 as the second processing amount (Operation S366). After Operation S366 and Operation S3621, the process proceeds to Operation S367.

The second acquiring unit 172 stores the second processing amount in the second file 152 so as to be associated with the VMID (Operation S367). The second acquiring unit 172 outputs the VMID and the second processing amount to the calculating unit 173 in order to calculate the third processing amount (Operation S368).

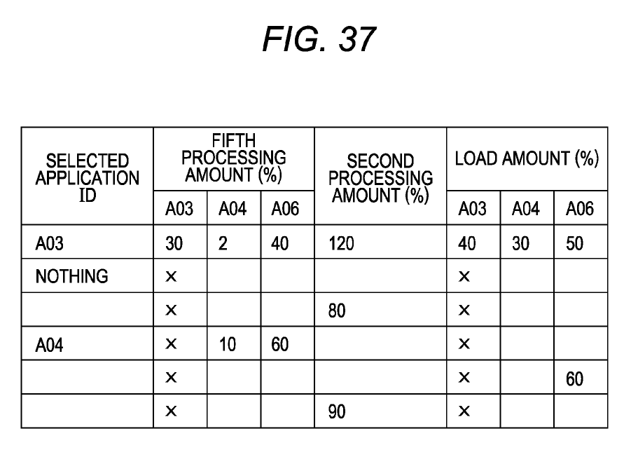

FIG. 37 illustrates a variation in the second processing amount. The applications 212 with application IDs ‘A03’, ‘A04’ and ‘A06’ are being executed. Currently, the application 212 with the application ID ‘A03’ is selected. The fifth processing amounts of the applications 212 are 30%, 2%, and 40%. The sum of the load amounts is 120 (=40+30+50). The second processing amount is 120, which is the sum of the load amounts.

Here, it is assumed that the application 212 with the application ID ‘A03’ is shut down. Since the application with the application ID ‘A03’ is shut down, it is represented by ‘X’. The sum of the load amounts is 80 (=30+50). Therefore, the second processing amount is 80. The application with the application ID ‘A04’ is selected, and the fifth processing amount of the application with the application ID ‘A06’ that is operated on the background is 60. Since the load amount of the application with the application ID ‘A06’ is 50, the fifth processing amount is more than the load amount. In this case, the load amount of the application with the application ID ‘A06’ in the load DB 156 is rewritten to 60. Therefore, the sum of the load amounts is 90 (=30+60). Finally, the sum of the second processing amounts is 90. In this way, it is possible to determine a state corresponding to the fifth processing amount related to the load of the application 212 that is being executed and thus provide the detailed state of the VM 2 to the user.

In the eighth embodiment, similar components as those in the first to seventh embodiments are denoted by the same reference numerals and a detailed description thereof will not be repeated here.

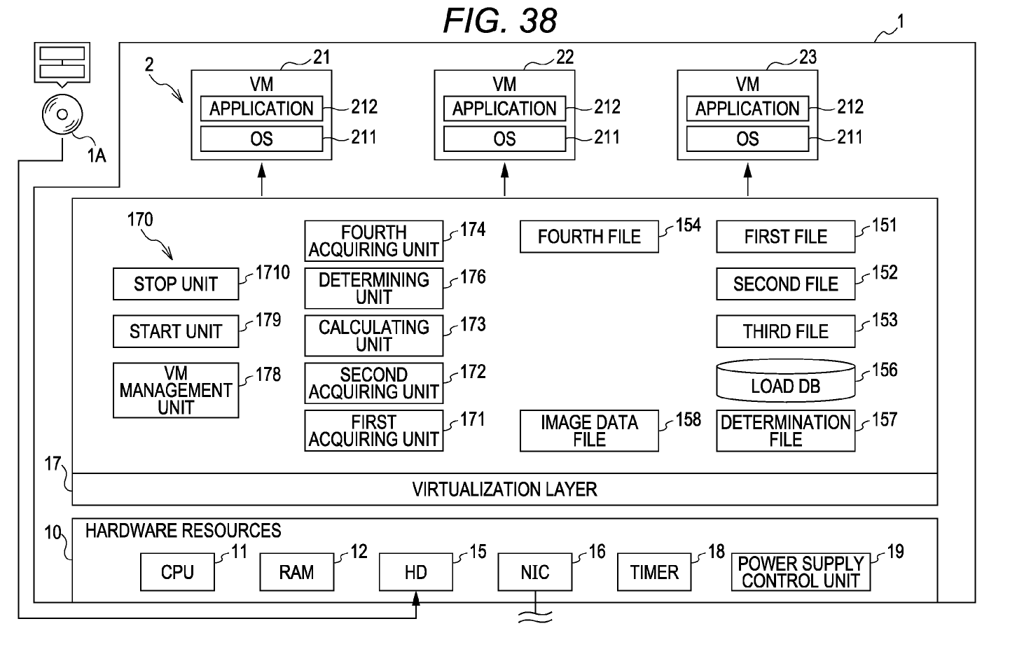

FIG. 38 illustrates the hardware and software of a physical machine 1 and VMs 2 according to a ninth embodiment. A program for operating the physical machine 1 according to the first to eighth embodiments may be read from a portable recording non-transitory medium 1A, such as a CD-ROM, by a read unit (not illustrated) and then stored in the HD 15, as in the ninth embodiment. In addition, the program may be downloaded from another server computer (not illustrated) that is connected to the physical machine through a communication network, such as the Internet. The content of the program is disclosed.

The physical machine 1 illustrated in FIG. 38 downloads a program for acquiring the first processing amount through the portable recording medium 1A or from another server computer (not illustrated) through a communication network. The program is installed as the control module 170, is loaded to the RAM 12, and is executed. In this way, the program serves as the physical machine 1.

In this embodiment, for example, the screen images of the OS 211 and the applications 212 may be changed into templates and the screen images may be transmitted to the computer 3 through the communication network. In the above-described embodiment, each of the VMs 2 has the OS 211, but it may not necessarily include the OS 211. For example, when the embodiment is applied to the X Window System, each of the VMs 2 may include the module 170 that has the same function as the OS 211. For example, like the second processing amount determining unit 1721, a module that outputs information indicating which of the applications 212 of the VM 2 is executed and selected to the second acquiring unit 172 may be prepared. Alternatively, the load DB 156 may be stored.

In the ninth embodiment, similar components as those in the first to eighth embodiments are denoted by the same reference numerals and a detailed description thereof will not be repeated here.

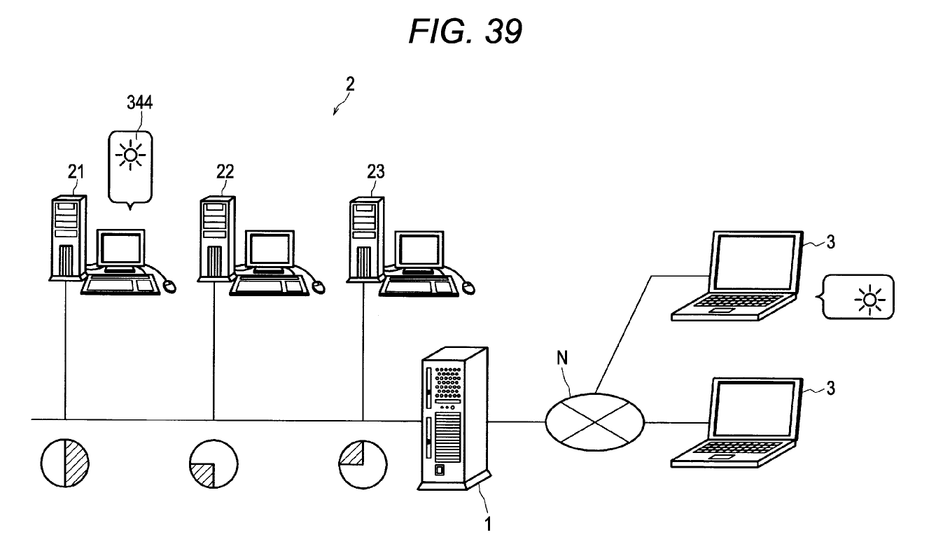

FIG. 39 illustrates a state output system according to a tenth embodiment. The state output system according to the tenth embodiment includes, for example, an operation environment 2, an information processing apparatus 1, a communication network N, and terminal apparatuses 3. The information processing apparatus 1 is, for example, a server computer that is connected to the communication network N, such as the Internet or a mobile telephone network. In the following description, the information processing apparatus 1 is referred to as a server computer 1. The server computer 1 is connected to operation environments 21, 22, 23, . . . (hereinafter, abbreviated as 2 according to circumstances) that are physically divided. The operation environment 2 is, for example, an application server that executes a plurality of applications 212 using a CGI (common gateway interface) in response to a request from the computer 3. Alternatively, the operation environment 2 may be, for example, a database server that searches information using an SQL (structured query language) in response to a request from the computer 3.

In this embodiment, the operation environment 2 is disclosed as the application server 2. The server computer 1 appropriately allocates the hardware resources 10 to the application server 2. In this embodiment, the occupancy of the NIC 16 in the server computer 1 per unit time is allocated. The occupancy is described as the first processing amount. As illustrated in FIG. 39, the largest first processing amount is allocated to the application server 21. Half of the first processing amount of the application server 21 is allocated to the application servers 22 and 23.

The application server 2 outputs the second processing amount to the server computer 1. The server computer 1 calculates the third processing amount on the basis of the difference between the first processing amount and the second processing amount. The server computer 1 determines a state on the basis of the second processing amount and the third processing amount. Then, image data 344 corresponding to the state is output to the display unit of each of the application servers 2. Alternatively, the server computer 1 or the application server 2 outputs the image data 344 to the computer 3 using the application server 2 through the communication network N.

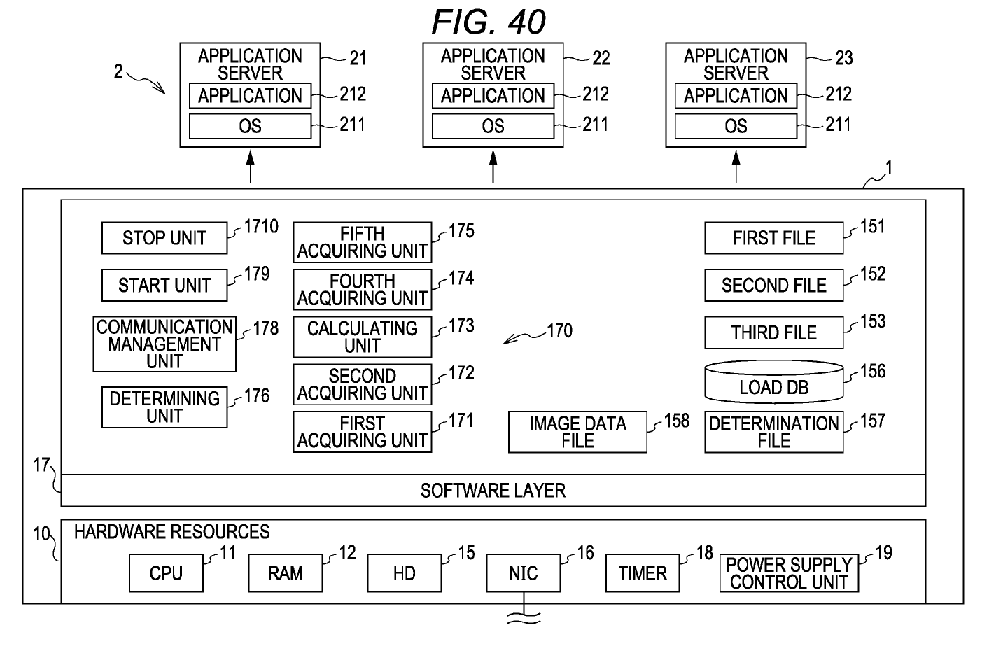

FIG. 40 illustrates the hardware and software of the server computer 1 and the application servers 2 according to the tenth embodiment. In the tenth embodiment, the virtualization layer 17 according to the above-described embodiments is replaced with a software layer 17. Instead of the VMs 2, the application servers 2 may be connected through the NIC 16. In addition, a communication management unit 178 is provided instead of the VM management unit 178. The module 170, various files, and the hardware resources 10 are similar as those in the above-described embodiments and thus a repeated description thereof will not be repeated here. The communication management unit 178 of the server computer 1 monitors data that is transmitted or received by the application servers 21, 22, and 23 through the NIC 16. The communication management unit 178 allocates the first processing amount indicating the occupancy of the NIC 16 to each application server 2 and also monitors the amount of data transmitted and received.

The application server 2 outputs the second processing amount that varies depending on the applications 212 to the second acquiring unit 172. When the computer 3 requests the application server 2 to execute a plurality of applications 212, the application server 2 performs the following process. The application server 2 outputs the IP (Internet protocol) address or MAC address of the application server and an application ID to the second acquiring unit 172 through a communication unit (not illustrated), instead of the VMID. A CPU (not illustrated) performs various processes. In the following description, the IP address is used by way of example. In this way, the second acquiring unit 172 reads a load amount from the load DB 156 and acquires the second processing amount.

The second processing amount that varies depending on the applications 212 may have the following structure. For example, when the application server 2 executes a single application 212, the application server 2 may perform the following process. The application server 2 extracts the amount of data received from a plurality of computers 3 per unit time, the number of requests to execute the applications 212 per unit time, or the number of computers 3 in a communication state. The number of execution requests per unit time is disclosed as an example. As the number of requests to execute the applications 212 which are output from a plurality of computers 3 is increased, the load of the application 212 being executed is increased. The application server 2 outputs the IP address and the number of requests to the server computer 1.

The second acquiring unit 172 of the server computer 1 receives the number of requests. A load amount that is increased according to the number of execution requests per unit time is stored in the load DB 156. The second acquiring unit 172 acquires a load amount corresponding to the number of execution requests as the second processing amount. The calculating unit 173 performs a similar process as that in the above-described embodiments to calculate the third processing amount. In addition, the determining unit 176 determines a state on the basis of, for example, the second processing amount and the third processing amount. The fourth processing amount indicates the occupancy of the application server 2 in the NIC 16 per unit time, and the fourth acquiring unit 174 acquires the fourth processing amount from the communication management unit 178.

When the application server 2 performs a plurality of applications 212, application IDs for specifying the applications 212 and data are transmitted to the computer 3 through the server computer 1. The fifth acquiring unit 175 acquires the occupancy of each application 212 in the NIC 16 per unit time as the fifth processing amount with reference to the header of a data packet. The application server 2 may monitor data that is transmitted or received and notify the amount of communication of each application to the fifth acquiring unit 175. The determining unit 176 outputs image data 344 corresponding to the determined state to each application server 2 through the NIC 16. The application server 2 outputs the image data 344 to the display unit of the application server 2 or the computer 3. In this way, the user of the computer 3 and the manager of the application server 2 can check the current state or the predicted state of the application server 2.

In the tenth embodiment, the same components as those in the first to ninth embodiments are denoted by the same reference numerals and a detailed description thereof will not be repeated here.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable non-transitory media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An information processing apparatus for controlling a plurality of divided operation environments, the apparatus comprising:
a first acquiring unit that acquires a first processing amount indicating an amount of hardware resources allocated to each of the operation environments;
a second acquiring unit that acquires a second processing amount which varies depending on an application program executed by the operation environment;
a calculating unit that calculates a third processing amount of each of the operation environments on the basis of a difference between the first processing amount of each operation environment acquired by the first acquiring unit and the second processing amount of each operation environment acquired by the second acquiring unit; and
an output unit that outputs a state of each of the operation environments on the basis of the third processing amount of each operation environment calculated by the calculating unit and the second processing amount of each operation environment acquired by the second acquiring unit.

2. The information processing apparatus according to claim 1, further comprising:
a read unit that reads image data from a storage unit, the image data being corresponding to the state of each of the operation environments output from the output unit,
wherein the output unit outputs the read image data to the outside so as to be associated with information for specifying the operation environments.

3. The information processing apparatus according to claim 1, further comprising:
a load amount read unit that, when an application program is selected, reads a load amount corresponding to the selected application program from a storage unit that stores the load amount of each application program,
wherein the second acquiring unit acquires the load amount read by the load amount read unit as the second processing amount.

4. The information processing apparatus according to claim 1, further comprising:
a load amount read unit that, when an application program is selected, reads a load amount from a storage unit that stores the load amount of each application program, the load amount being corresponding to the selected application program; and
a fourth acquiring unit that acquires a fourth processing amount indicating the ratio of the amount of hardware resources consumed by each operation environment,
wherein, when the fourth processing amount acquired by the fourth acquiring unit is more than the load amount read by the load amount read unit, the second acquiring unit acquires the fourth processing amount as the second processing amount, and
when the fourth processing amount acquired by the fourth acquiring unit is not more than the load amount read by the load amount read unit, the second acquiring unit acquires the load amount read by the load amount read unit as the second processing amount.

5. The information processing apparatus according to claim 1, further comprising:
a sum calculating unit that reads the load amounts corresponding to the application programs executed by the operation environments from a storage unit that stores the load amounts of the application programs and calculates the sum of the read load amounts,
wherein the second acquiring unit acquires the sum calculated by the sum calculating unit as the second processing amount.

6. The information processing apparatus according to claim 1, further comprising:
a sum calculating unit that reads the load amounts corresponding to the application programs executed by the operation environments from a storage unit that stores the load amounts of the application programs and calculates the sum of the read load amounts;
a fifth acquiring unit that acquires a fifth processing amount indicating the ratio of the amount of hardware resources consumed by each of the application programs executed by the operation environments;
a load determining unit that determines whether the fifth processing amount of the application program being executed, which is acquired by the fifth acquiring unit, is more than the load amount of the application program being executed, which is read from the storage unit; and
a rewrite unit that rewrites the load amount of the application program being executed to the fifth processing amount when the load determining unit determines that the fifth processing amount is more than the load amount,
wherein, when the load determining unit determines that the fifth processing amount is not more than the load amount, the second acquiring unit acquires the sum calculated by the sum calculating unit as the second processing amount, and
when the load determining unit determines that the fifth processing amount is more than the load amount, the second acquiring unit acquires the sum of the load amounts calculated by the sum calculating unit as the second processing amount on the basis of the load amount rewritten by the rewrite unit.

7. A computer readable non-transitory storage medium that stores a program for allowing an information processing apparatus which controls a plurality of divided operation environments to function as:
a first acquiring unit that acquires a first processing amount indicating an amount of hardware resources of the information processing apparatus allocated to each of the operation environments;
a second acquiring unit that acquires a second processing amount which varies depending on an application program executed by the operation environment;
a calculating unit that calculates a third processing amount of each of the operation environments on the basis of a difference between the first processing amount acquired by the first acquiring unit and the second processing amount acquired by the second acquiring unit for each operation environment; and
an output unit that outputs the state of each of the operation environments on the basis of the third processing amount calculated by the calculating unit and the second processing amount acquired by the second acquiring unit for each operation environment.

8. The storage medium according to claim 7,
wherein the output unit outputs the state of each of the operation environments according to the magnitude relationship between the third processing amount of each operation environment calculated by the calculating unit and the second processing amount of each operation environment acquired by the second acquiring unit.

9. The storage medium according to claim 7,
wherein the output unit outputs the state of each of the operation environments according to the magnitude relationship among the third processing amount of each operation environment calculated by the calculating unit, the second processing amount of each operation environment acquired by the second acquiring unit, and the first processing amount of each operation environment acquired by the first acquiring unit.

10. The storage medium according to claim 7,
wherein the program allows the information processing apparatus to function as a fourth acquiring unit that acquires a fourth processing amount indicating the ratio of the amount of hardware resources consumed by each of the operation environments, and
the output unit outputs the state of each of the operation environments according to the magnitude relationship among the third processing amount of each operation environment calculated by the calculating unit, the second processing amount of each operation environment acquired by the second acquiring unit, and the fourth processing amount of each operation environment acquired by the fourth acquiring unit.

11. The storage medium according to claim 7,
wherein the program allows the information processing apparatus to function as a fourth acquiring unit that acquires a fourth processing amount indicating the ratio of the amount of hardware resources consumed by each of the operation environments, and
the output unit includes:
a state output unit that outputs the state of each of the operation environments according to the magnitude relationship among the third processing amount of each operation environment calculated by the calculating unit, the second processing amount of each operation environment acquired by the second acquiring unit, the fourth processing amount of each operation environment acquired by the fourth acquiring unit, and the first processing amount of each operation environment acquired by the first acquiring unit; and
a predicted state output unit that outputs a predicted state following the state output by the state output unit according to the magnitude relationship among the third processing amount of each operation environment calculated by the calculating unit, the second processing amount of each operation environment acquired by the second acquiring unit, the fourth processing amount of each operation environment acquired by the fourth acquiring unit, and the first processing amount of each operation environment acquired by the first acquiring unit.

12. The storage medium according to claim 7,
wherein the calculating unit includes:
a sum calculating unit that calculates the sum of values obtained by subtracting the second processing amount from the first processing amount of each of the operation environments when the first processing amount acquired by the first acquiring unit is more than the second processing amount acquired by the second acquiring unit;
an extracting unit that extracts the first processing amount of the operation environment in which the second processing amount acquired by the second acquiring unit is more than the first processing amount acquired by the first acquiring unit; and
a third processing amount calculating unit that distributes the sum calculated by the sum calculating unit to the first processing amount of the operation environment extracted by the extracting unit to calculate the third processing amount of the operation environment.

13. The storage medium according to claim 12,
wherein the calculating unit further includes:
a determining unit that determines the first processing amount of the operation environment in which the first processing amount acquired by the first acquiring unit is more than the second processing amount acquired by the second acquiring unit as the third processing amount of the operation environment.

14. The storage medium according to claim 7,
wherein the calculating unit includes:
a sum calculating unit that calculates the sum of values obtained by subtracting the second processing amount from the first processing amount of each of the operation environments when the first processing amount acquired by the first acquiring unit is more than the second processing amount acquired by the second acquiring unit;
an auxiliary sum calculating unit that calculates the auxiliary sum of values obtained by subtracting the first processing amount from the second processing amount of each of the operation environments when the second processing amount acquired by the second acquiring unit is more than the first processing amount acquired by the first acquiring unit;
a determining unit that determines whether the sum calculated by the sum calculating unit is more than the auxiliary sum calculated by the auxiliary sum calculating unit;
an extracting unit that extracts the first processing amount of the operation environment in which the second processing amount acquired by the second acquiring unit is more than the first processing amount acquired by the first acquiring unit when the determining unit determines that the sum is not more than the auxiliary sum; and
a third processing amount calculating unit that distributes the sum calculated by the sum calculating unit to the first processing amount of the operation environment extracted by the extracting unit to calculate the third processing amount of the operation environment.

15. The storage medium according to claim 14,
wherein the calculating unit further includes:
a determining unit that determines the first processing amount of the operation environment in which the first processing amount acquired by the first acquiring unit is more than the second processing amount acquired by the second acquiring unit as the third processing amount of the operation environment when the determining unit determines that the sum is not more than the auxiliary sum.

16. The storage medium according to claim 15,
wherein the calculating unit further includes:
an auxiliary extracting unit that extracts the second processing amount of the operation environment in which the second processing amount acquired by the second acquiring unit is more than the first processing amount acquired by the first acquiring unit when the determining unit determines that the sum is more than the auxiliary sum; and
an auxiliary determining unit that determines the second processing amount of the operation environment extracted by the auxiliary extracting unit as the third processing amount of the operation environment.

17. A method of outputting the state of an information processing apparatus that controls a plurality of divided operation environments, the method comprising:
acquiring a first processing amount indicating the amount of hardware resources of the information processing apparatus allocated to each of the operation environments;
acquiring a second processing amount which varies depending on an application program executed by the operation environment;
calculating a third processing amount of each of the operation environments on the basis of a difference between the first processing amount and the second processing amount; and
outputting the state of each of the operation environments on the basis of the third processing amount and the second processing amount.

18. An information processing apparatus comprising:
a first unit that acquires data regarding hardware resources allocated to each of a plurality of environments;
a second unit that acquires data that varies depending on an application program executed by an environment;
a third unit that calculates a processing amount of each of the environments based on the first data and the second data; and
an output unit that outputs a state of each of the environments based on the calculated processing amount.
